(19) United States
(12) Patent Application Publication
(10) Pub. No.: US 2020/0071560 A1
(43) Pub. Date: Mar. 5, 2020

(54) ANTIFOULING FILM

(71) Applicant: Sharp Kabushiki Kaisha, Sakai City, Osaka (JP)

(72) Inventors: Yasuhiro SHIBAI, Sakai City (JP); Ken ATSUMO, Sakai City (JP); Kenichiro NAKAMATSU, Sakai City (JP)

(21) Appl. No.: 16/495,462

(22) PCT Filed: Mar. 14, 2018
(86) PCT No.: PCT/JP2018/009837

§ 371 Date: Sep. 19, 2019

(30) Foreign Application Priority Data
Mar. 21, 2017 (JP) 2017-054454

(51) Int. Cl. C09D 135/02; C09D 5/00; C09D 7/65

(52) U.S. Cl. CPC C09D 135/02; C09D 7/65; C09D 5/00

(57) ABSTRACT

The An antifouling film includes: a substrate; and a polymer layer including on a surface thereof an uneven structure provided with projections at a pitch not longer than a wavelength of visible light. The polymer layer is a cured product of a polymerizable composition. The polymerizable composition contains, in terms of active components, 75 to 98 wt % of a polyfunctional acrylate, 0.5 to 10 wt % of a fluorine-based release agent, and 1 to 14 wt % of a monofunctional amide monomer. The polymer layer has a bottom temperature at which a storage modulus E′ of the polymer layer is minimum of 90° C. to 150° C. and a minimum storage modulus E′ of 0.9×108 to 4.5×108 Pa in a dynamic viscoelasticity measurement within a measurement temperature range of −50° C. to 250° C. and at a temperature increasing rate of 5° C./min and a frequency of 10 Hz.

### TECHNICAL FIELD

The present invention relates to antifouling films. The present invention specifically relates to an antifouling film including an uneven structure of nanometer scale.

BACKGROUND ART

Various products formed from curable resin, such as optical films, have been studied (e.g., Patent Literatures 1 to 9). In particular, optical films including an uneven structure of nanometer scale (nanostructure) are known for their excellent antireflective properties. This uneven structure has a continuously varying refractive index from the air layer to the substrate, thereby capable of reducing the reflected light significantly.

### CITATION LIST

### Patent Literature

Patent Literature 1: JP 2012-52125 A
Patent Literature 2: WO 2007/040159
Patent Literature 3: WO 2011/118591
Patent Literature 4: WO 2011/118734
Patent Literature 5: WO 2012/105539
Patent Literature 6: JP 2012-247681 A
Patent Literature 7: JP 2015-129947 A
Patent Literature 8: WO 2011/115162
Patent Literature 9: WO 2014/171302

### SUMMARY OF INVENTION

### Technical Problem

Although such optical films have excellent antireflective properties, the uneven structure on the surface may cause easy spread of dirt such as fingerprints (sebaceous dirt) sticking thereon and further cause difficulty in wiping off such dirt present between projections. Such sticking dirt has a reflectance that is very different from the reflectance of the optical film, and thus is noticeable. This has increased the demand for functional films (antifouling films) including on their surface an uneven structure of nanometer scale and showing excellent ease of wiping off dirt (e.g., ease of wiping off fingerprints), i.e., excellent antifouling properties.

The present inventors made studies on such films, and found that an antifouling film increased in antifouling properties and other various properties can be achieved by devising the materials of the polymer layer constituting the uneven structure of the optical film. Specifically, using a fluorine-based release agent as a material of the polymer layer was found to increase the antifouling properties, using a polyfunctional acrylate as a material of the polymer layer was found to increase the rubbing resistance, and using a monofunctional amide monomer was found to increase the adhesion between the polymer layer and the substrate of the antifouling film. Also, increasing the crosslinking density of the polymer layer and decreasing the glass transition temperature thereof were found to significantly increase the rubbing resistance.

However, the inventors found through further studies that using a monofunctional amide monomer as a material of the polymer layer tends to reduce the crosslinking density of the polymer layer and to increase the glass transition temperature, leading to reduced rubbing resistance. The study also revealed that, in formation of the uneven structure of the antifouling film using a die, if a large amount of the monofunctional amide monomer is contained as a material of the polymer layer, the releasing properties of the polymer layer and the die tend to decrease as the number of die transfer times increases, leading to reduced antifouling properties of the resulting antifouling film. The inventors thus made a study for not using the monofunctional amide monomer as a material of the polymer layer but failed in ensuring the adhesion.

As described above, although the conventional antifouling films are desired to be higher in all the antifouling properties, rubbing resistance, and adhesion, no way to achieve such higher properties has been found. For example, the inventions described in Patent Literatures 1 to 9 fail to increase the antifouling properties, rubbing resistance, and adhesion at the same time, and thus can still be improved.

In response to the above issues, an object of the present invention is to provide an antifouling film that is excellent in antifouling properties, rubbing resistance, and adhesion.

### Solution to Problem

The inventors made various studies on an antifouling film that is excellent in antifouling properties, rubbing resistance, and adhesion. The inventors then found that a polyfunctional acrylate, a fluorine-based release agent, and a monofunctional amide monomer are used as materials of the polymer layer with the amount of the monofunctional amide monomer minimized, while the minimum storage elastic modulus E′ of the polymer layer and the bottom temperature at the minimum storage elastic modulus E′ are allowed to fall within a predetermined range. Thereby, the inventors successfully achieved the above object, arriving at the present invention.

In other words, one aspect of the present invention may be an antifouling film including: a substrate; and a polymer layer disposed on a surface of the substrate and including on a surface thereof an uneven structure provided with projections at a pitch not longer than a wavelength of visible light, the polymer layer being a cured product of a polymerizable composition, the polymerizable composition containing, in terms of active components, 75 to 98 wt % of a polyfunctional acrylate, 0.5 to 10 wt % of a fluorine-based release agent, and 1 to 14 wt % of a monofunctional amide monomer, the polymer layer having a bottom temperature at which a storage modulus E′ of the polymer layer is minimum of 90° C. to 150° C. and a minimum storage modulus E′ of 0.9×10⁸ to 4.5×10⁸ Pa in a dynamic viscoelasticity measurement within a measurement temperature range of −50° C. to 250° C. and at a temperature increasing rate of 5° C./min and a frequency of 10 Hz.

The polyfunctional acrylate may include a bifunctional acrylate that contains 2 to 10 ethylene oxide groups for each molecule, and the polymerizable composition may contain 30 to 90 wt % of the bifunctional acrylate in terms of active components.

The bifunctional acrylate may include 2-(2-vinyloxyethoxy)ethyl acrylate, and the polymerizable composition may contain 20 to 60 wt % of the 2-(2-vinyloxyethoxy)ethyl acrylate in terms of active components.

The fluorine-based release agent may include one or both of a first fluorine-based release agent containing a perfluoro polyether group and a second fluorine-based release agent containing a perfluoro alkyl group.

The fluorine-based release agent may include both of the first fluorine-based release agent and the second fluorine-based release agent.

The monofunctional amide monomer may include N,N-dimethylacrylamide.

The monofunctional amide monomer may include N-acryloyl morpholine.

The polymer layer may have a surface that shows a contact angle of 130° or greater with water and a contact angle of 30° or greater with hexadecane.

The polymer layer may have a thickness of 5.0 to 20.0 μm.

The projections may be formed at an average pitch of 100 to 400 nm.

The projections may have an average height of 50 to 600 nm.

The projections may have an average aspect ratio of 0.8 to 1.5.

### Advantageous Effects of Invention

The present invention can provide an antifouling film that is excellent in antifouling properties, rubbing resistance, and adhesion. Also, the present invention can suppress a reduction in antifouling properties even when the number of die transfer times increases.

### BRIEF DESCRIPTION OF DRAWINGS

FIG. 1 is a schematic cross-sectional view of an antifouling film of an embodiment.

FIG. 2 is a schematic plan view of a polymer layer in FIG. 1.

FIG. 3 includes plan images each showing the state of the surface of the polymer layer of an antifouling film after rubbing; FIG. 3(a) shows the case where the bottom temperature and minimum storage elastic modulus E′ of the polymer layer each fall within an appropriate range, FIG. 3(b) shows the case where the minimum storage elastic modulus E′ of the polymer layer is lower than that in FIG. 3(a), and FIG. 3(c) shows the case where one or both of the bottom temperature and minimum storage elastic modulus E′ of the polymer layer is higher than that in FIG. 3(a).

FIG. 4 includes schematic cross-sectional views illustrating an exemplary method for producing the antifouling film of the embodiment.

FIG. 5 is a graph showing the measurement results of the storage elastic modulus E′ of the polymer layer of the antifouling film of Example 1.

### DESCRIPTION OF EMBODIMENTS

The present invention is described in more detail based on the following embodiment with reference to the drawings. The embodiment, however, is not intended to limit the scope of the present invention. The configurations of the embodiment may appropriately be combined or modified within the spirit of the present invention.

The expression “X to Y” as used herein means “X or more and Y or less”.

### Embodiment

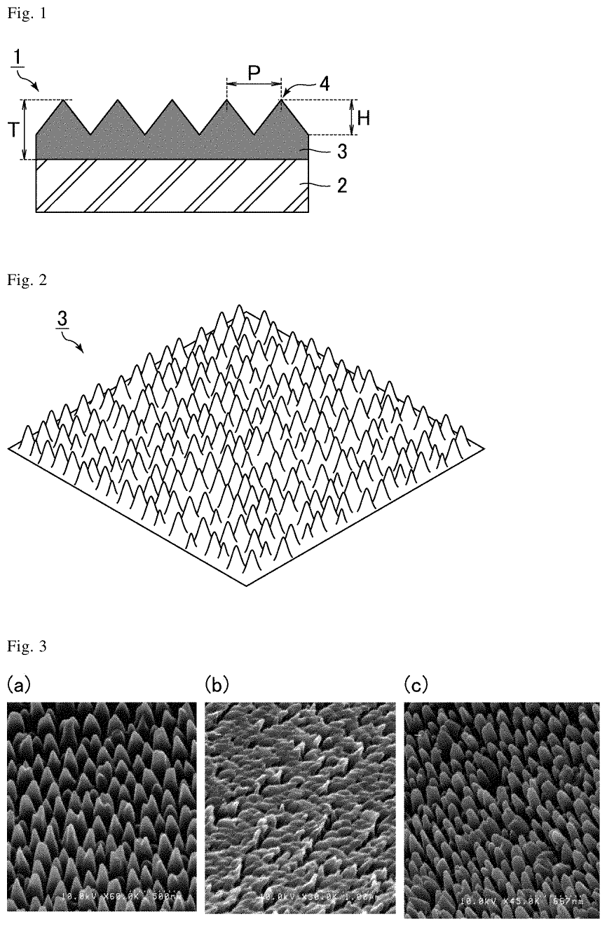

An antifouling film of an embodiment is described below with reference to FIG. 1 and FIG. 2. FIG. 1 is a schematic cross-sectional view of the antifouling film of the embodiment. FIG. 2 is a schematic plan view of a polymer layer in FIG. 1.

An antifouling film 1 includes a substrate 2 and a polymer layer 3 disposed on a surface of the substrate 2.

The material of the substrate 2 may be, for example, a resin such as triacetyl cellulose (TAC), polyethylene terephthalate (PET), or methyl methacrylate (MMA). The substrate 2 may further contain appropriate additive(s) such as a plasticizer in addition to the above material. One surface (the surface close to the polymer layer 3) of the substrate 2 may have undergone easy adhesion treatment (e.g., primer treatment). For example, a triacetyl cellulose film after easy adhesion treatment may be used. One surface (the surface close to the polymer layer 3) of the substrate 2 may have undergone saponification treatment. For example, a saponified triacetyl cellulose film may be used. When the antifouling film 1 is mounted on a display device provided with a polarizing plate, such as a liquid crystal display device, the substrate 2 may be part of the polarizing plate.

The substrate 2 preferably has a thickness of 50 to 100 μm in order to ensure the transparency and processability.

The polymer layer 3 includes on a surface thereof an uneven structure on which multiple projections (protrusions) 4 are disposed with a pitch (distance between the apexes of adjacent projections 4) P not longer than the wavelength (780 nm) of visible light, i.e., a moth-eye structure (a structure like a moth's eye). Thus, the antifouling film 1 can exert excellent antireflective properties (low reflectivity) owing to the moth-eye structure.

The polymer layer 3 has a thickness T, which is preferably small in order to distribute active components in the later-described fluorine-based release agent at a high concentration on the surface (the surface remote from the substrate 2) of the polymer layer 3. Specifically, the polymer layer 3 has a thickness T of preferably 5.0 to 20.0 μm, more preferably 8.0 to 12.0 μm. The thickness T of the polymer layer 3 indicates, as shown in FIG. 1, the distance from the surface close to the substrate 2 to the apex of a projection 4.

Examples of the shape of the projection 4 include those tapering toward the tip (tapered shapes) such as shapes consisting of a columnar lower part and a hemispherical upper part (temple-bell-like shapes) and conical shapes (cone-like shapes, circular-cone-like shapes). In FIG. 1, the bases of the gaps between any adjacent projections 4 are inclined, but the bases may not be inclined but may be flat.

The projections 4 are formed at an average pitch of preferably 100 to 400 nm, more preferably 100 to 200 nm, for sufficient prevention of optical phenomena such as moire and iridescence. The average pitch of the projections 4 specifically means the average pitch (P in FIG. 1) of all the adjacent projections within a 1-μm-square region in a plan image taken by a scanning electron microscope.

The projections 4 have an average height of preferably 50 to 600 nm, more preferably 100 to 300 nm, for simultaneous achievement of the preferred average height and the later-described preferred average aspect ratio of the projections 4. The average height of the projections 4 specifically means the average value of the heights (H in FIG. 1) of 10 consecutive projections in a cross-sectional image taken by a scanning electron microscope. These 10 projections were selected so as not to include projections having any defect or deformed portion (e.g., a portion accidentally deformed during preparation of a measurement sample).

The projections 4 have an average aspect ratio of preferably 0.8 to 1.5, more preferably 1.0 to 1.3. If the average aspect ratio of the projections 4 is smaller than 0.8, the film may insufficiently prevent occurrence of optical phenomena such as moire and iridescence, possibly failing to achieve good antireflective properties. If the average aspect ratio of the projections 4 is greater than 1.5, the processability of the uneven structure may be poor, sticking may occur, and transfer conditions in formation of the uneven structure may be poor (e.g., clogging of a die 6, twining of the material). The average aspect ratio of the projections 4 as used herein means the ratio of the average height of the projections 4 to the average pitch of the projections 4 (height/pitch).

The projections 4 may be arranged either randomly or regularly (periodically). The projections 4 may be arranged with periodicity. Yet, in terms of advantages such as no generation of diffracted light due to the periodicity, the projections 4 are preferably arranged with no periodicity (arranged randomly) as shown in FIG. 2.

The polymer layer 3 is a cured product of a polymerizable composition. Examples of the polymer layer 3 include a cured product of an active energy ray-curable polymerizable composition and a cured product of a thermosetting polymerizable composition. The active energy rays include ultraviolet rays, visible light, infrared rays, and plasma, for example. The polymer layer 3 is preferably a cured product of an active energy ray-curable polymerizable composition, more preferably a cured product of an ultraviolet ray-curable polymerizable composition.

The polymerizable composition contains, in terms of active components, 75 to 98 wt % of a polyfunctional acrylate (hereinafter, also referred to as Component A), 0.5 to 10 wt % of a fluorine-based release agent (hereinafter, also referred to as Component B), and 1 to 14 wt % of a monofunctional amide monomer (hereinafter, also referred to as Component C).

The active components of the polymerizable composition (active components of Components A to C) refer to those constituting the polymer layer 3 after curing, excluding those not contributing to the curing reaction (polymerization reaction) (e.g., solvent).

The polymerizable composition, containing the above proportions of Components A to C, may also contain other component(s).

Components A to C are described below.

### <Component A>

Component A increases the crosslinking density of the polymer layer 3 and provides an appropriate elasticity (hardness) to the polymer layer 3, increasing the rubbing resistance. Component A (polyfunctional acrylate) herein means an acrylate which contains at least an acryloyl group and in which the total number of acryloyl groups and polymerizable functional groups other than the acryloyl groups is 2 or more, for each molecule. The polymerizable functional group other than the acryloyl group means at least one functional group selected from the group consisting of methacryloyl, vinyl, vinyl ether, and allyl groups.

The polymerizable composition has a Component A content in terms of active components of 75 to 98 wt %, preferably 80 to 97.5 wt %, more preferably 85 to 95 wt %. When the polymerizable composition has a Component A content in terms of active components of lower than 75 wt %, the polymer layer 3 has significantly high hardness to have reduced rubbing resistance. When the polymerizable composition has a Component A content in terms of active components of higher than 98 wt %, the polymer layer 3 has a significantly low crosslinking density to have reduced rubbing resistance. In the case where the polymerizable composition contains a plurality of Components A, the total of Component A contents in terms of active components should fall within the above range.

The number of functional groups of Component A is 2 or more, preferably 4 or more, more preferably 6 or more. Component A with too many functional groups has a large molecular weight to reduce the compatibility with Component B, thereby possibly reducing the transparency of the polymerizable composition and the antifouling film 1. Such Component A may also reduce the adhesion due to the shrinkage on curing of the polymerizable composition. From this viewpoint, a preferred upper limit of the number of functional groups in Component A is 10. Here, the number of functional groups in Component A means the total number of acryloyl groups and polymerizable functional groups other than the acryloyl groups for each molecule (the number of acryloyl groups is 1 or more).

Component A preferably contains a bifunctional acrylate that contains 2 to 10 ethylene oxide groups for each molecule (hereinafter, also simply referred to as a bifunctional acrylate). The polymerizable composition preferably contains 30 to 90 wt % of the bifunctional acrylate in terms of active components. The bifunctional acrylate has a low glass transition temperature and can give better elasticity to the polymer layer 3 to increase the rubbing resistance. The bifunctional acrylate has a low viscosity and thus has a high compatibility with Component B, and therefore can function as a compatibilizer. The bifunctional acrylate increases the interaction with the substrate 2 owing to the high polarity of the ethylene oxide group. As a result, the adhesion increases and thereby the amount of Component C can be minimized. Hence, the rubbing resistance and the adhesion can be more increased by allowing the amount of the bifunctional acrylate in the polymerizable composition to fall within the above range in terms of active components.

In the bifunctional acrylate, the number of ethylene oxide groups for each molecule is preferably 2 to 10, more preferably 2 to 9.

The polymerizable composition has a bifunctional acrylate content in terms of active components of preferably 30 to 90 wt %, more preferably 35 to 85 wt %, still more preferably 39 to 81 wt %.

In terms of the rubbing resistance and adhesion, the bifunctional acrylate preferably includes 2-(2-vinyloxyethoxy)ethyl acrylate, and the polymerizable composition preferably contains 20 to 60 wt % of 2-(2-vinyloxyethoxy)ethyl acrylate in terms of active components. The polymerizable composition more preferably contains 30 to 50 wt % of 2-(2-vinyloxyethoxy)ethyl acrylate in terms of active components.

Examples of Component A include urethane acrylate, ethoxylated polyglycerin polyacrylate, alkoxylated dipentaerythritol polyacrylate, ethoxylated pentaerythritol tetraacrylate, propoxylated pentaerythritol tri- and tetra-acrylates, trimethylolpropane triacrylate, ethoxylated(6) trimethylolpropane triacrylate, ethoxylated glycerol triacrylate, 2-(2-vinyloxyethoxy)ethyl acrylate, polyethylene glycol(300) diacrylate, polyethylene glycol(400) diacrylate, polypropylene glycol(400) diacrylate, and polypropylene glycol(700) diacrylate.

Known examples of the urethane acrylate include “U-10HA” (the number of functional groups: 10, the number of ethylene oxide groups: 0 (not contained)) from Shin-Nakamura Chemical Co., Ltd. and “Kayarad® UX-5000” (the number of functional groups: 6, the number of ethylene oxide groups: 0 (not contained)) from Nippon Kayaku Co., Ltd. Known examples of the ethoxylated polyglycerin polyacrylate include “NK Economer® A-PG5027E” (the number of functional groups: 9, the number of ethylene oxide groups: 27 for each molecule) from Shin-Nakamura Chemical Co., Ltd. Known examples of the alkoxylated dipentaerythritol polyacrylate include “Kayarad DPCA-60” (the number of functional groups: 6, the number of ethylene oxide groups: 0 (not contained)) and “Kayarad DPEA-12” (the number of functional groups: 6, the number of ethylene oxide groups: 12 for each molecule) from Nippon Kayaku Co., Ltd. Known examples of the ethoxylated pentaerythritol tetraacrylate include “NK Ester ATM-35E” (the number of functional groups: 4, the number of ethylene oxide groups: 35 for each molecule) from Shin-Nakamura Chemical Co., Ltd. Known examples of the propoxylated pentaerythritol tri- and tetra-acrylate include “NK Ester ATM-4PL” (the number of functional groups: 4, the number of ethylene oxide groups: 0 (not contained)) from Shin-Nakamura Chemical Co., Ltd. Known examples of the trimethylolpropane triacrylate include “SR351NS” (the number of functional groups: 3, the number of ethylene oxide groups: 0 (not contained)) from Arkema K.K. Known examples of the ethoxylated(6) trimethylolpropane triacrylate include “SR499NS” (the number of functional groups: 3, the number of ethylene oxide groups: 6 for each molecule) from Arkema K.K. Known examples of the ethoxylated glycerol triacrylate include “NK Ester A-GLY-3E” (the number of functional groups: 3, the number of ethylene oxide groups: 3 for each molecule) from Shin-Nakamura Chemical Co., Ltd. Known examples of the 2-(2-vinyloxyethoxy)ethyl acrylate include “VEEA” (the number of functional groups: 2, the number of ethylene oxide groups: 2 for each molecule) from Nippon Shokubai Co., Ltd. Known examples of the polyethylene glycol(300) diacrylate include “New Frontier® PE-300” (the number of functional groups: 2, the number of ethylene oxide groups: 6 for each molecule) from DKS Co. Ltd. Known examples of the polyethylene glycol(400) diacrylate include “SR344” (the number of functional groups: 2, the number of ethylene oxide groups: 9 for each molecule) from Arkema K.K. Known examples of the polypropylene glycol(400) diacrylate include “NK Ester APG-400” (the number of functional groups: 2, the number of ethylene oxide groups: 0 (not contained)) from Shin-Nakamura Chemical Co., Ltd. Known examples of the polypropylene glycol(700) diacrylate include “NK Ester APG-700” (the number of functional groups: 2, the number of ethylene oxide groups: 0 (not contained)) from Shin-Nakamura Chemical Co., Ltd. The 2-(2-vinyloxyethoxy) ethyl acrylate herein is a hybrid monomer containing a vinyl ether group and an acryloyl group as polymerizable functional groups (the number of functional groups: 2).

### <Component B>

Component B distributes the active components therein on the surface (the surface remote from the substrate 2) of the polymer layer 3 to reduce the surface free energy of the polymer layer 3, thereby increasing the antifouling properties. Component B further enhances the smoothness to increase the rubbing resistance. Component B (fluorine-based release agent) herein means a component that contains as an active component a compound (fluorine-based compound) containing a fluorine atom in its molecule.

The polymerizable composition has a Component B content in terms of active components of 0.5 to 10 wt %, preferably 1 to 5 wt %, more preferably 1.5 to 3 wt %. When the polymerizable composition has a Component B content of lower than 0.5 wt % in terms of active components, the amount of active components distributed on the surface (the surface remote from the substrate 2) of the polymer layer 3 is significantly small, resulting in reduced antifouling properties. The smoothness is also reduced, resulting in reduced rubbing resistance. When the polymerizable composition has a Component B content of higher than 10 wt % in terms of active components, the compatibilities with Component A and with Component C are significantly low to prevent the active components in Component B from being uniformly distributed on the surface (the surface remote from the substrate 2) of the polymer layer 3, resulting in reduced antifouling properties and rubbing resistance. Thereby, the active components in Component B are likely to be distributed on the substrate 2 side of the polymer layer 3, resulting in reduced adhesion. Furthermore, bleed-out is likely to occur in a high temperature/high humidity environment, resulting in reduced reliability (optical properties). In the case where the polymerizable composition contains a plurality of Components B, the total of Component B contents in terms of active components should fall within the above range.

Component B preferably includes one or both of a first fluorine-based release agent containing a perfluoro polyether group and a second fluorine-based release agent containing a perfluoro alkyl group. The first fluorine-based release agent containing a perfluoro polyether group, containing a fluorine-based monomer that tends to move, tends to improve the smoothness of the surface (the surface remote from the substrate 2) of the polymer layer 3, and thus tends to improve the rubbing resistance. The second fluorine-based release agent containing a perfluoro alkyl group, having a small molecular weight, tends to be distributed on (tends to move to) the surface (the surface remote from the substrate 2) of the polymer layer 3. Thus, even with a small amount thereof, the desired antifouling properties and rubbing resistance tend to be achieved. Fluorine-based release agents such as the first fluorine-based release agent and the second fluorine-based release agent achieve better antifouling properties and rubbing resistance than release agents (e.g., silicon-based release agents, organophosphate-based release agents) other than fluorine-based release agents.

From the above viewpoints, Component B preferably includes both of the first fluorine-based release agent and the second fluorine-based release agent. This tends to allow easy distribution (move) of the first fluorine-based release agent on (to) the surface (the surface remote from the substrate 2) of the polymer layer 3 by the act of the second fluorine-based release agent to achieve significantly better antifouling properties and rubbing resistance than the case of using one of the first fluorine-based release agent and the second fluorine-based release agent alone.

Known examples of Component B include “Fomblin® MT70” and “Fomblin AD1700” from Solvay, “Optool® DAC” and “Optool DAC-HP” from Daikin Industries, Ltd., “Megaface® RS-76-NS” from DIC Corporation, and “Cheminox® FAAC-4” and “Cheminox FAAC-6” from Unimatec Corporation.

### <Component C>

Component C suppresses the shrinkage on curing of the polymerizable composition and increases the cohesive force with the substrate 2 to improve the adhesion. Component C has high compatibility with Components A and B and thus can function as a compatibilizer. Unfortunately, addition of Component C to the polymerizable composition reduces the crosslinking density of the polymer layer 3 and thus tends to increase the glass transition temperature, whereby the rubbing resistance tends to decrease. Furthermore, in formation of the uneven structure of the antifouling film 1 using a die (the later-described die 6), a large amount of Component C contained in the polymerizable composition may cause permeation of Component C to the surface of the die during die transfer (when the die is in contact with the polymerizable composition). Here, when the surface of the die has been subjected to a release treatment with a release treatment agent (e.g., fluorine-based material) in advance, Component C permeated is compatible with the release treatment agent on the die, whereby the release treatment agent tends to separate from the die. Accordingly, the releasing properties of the polymer layer 3 and the die tend to decrease as the number of die transfer times increases, resulting in reduced antifouling properties of the antifouling film 1.

In order to avoid such troubles, in the present embodiment, the amount of Component C is minimized to achieve ensuring the adhesion and suppressing a reduction in antifouling properties accompanied by an increase in the number of die transfer times, as described below. Furthermore, allowing each of the minimum storage elastic modulus E′ of the polymer layer 3 and the bottom temperature at the minimum storage elastic modulus E′ to fall within a predetermined range can achieve excellent rubbing resistance even when the polymerizable composition contains Component C, as described below. Component C (monofunctional amide monomer) herein means a monomer that contains an amide group and contains one acryloyl group for each molecule.

The polymerizable composition has a Component C content in terms of active components of 1 to 14 wt %, preferably 1.5 to 10 wt %, more preferably 2 to 6 wt %. In other words, the amount of the amide group derived from Component C in the polymerizable composition is 0.1 to 1.4 mmol/g, preferably 0.15 to 1.0 mmol/g, more preferably 0.2 to 0.6 mmol/g. When the Component C content in the polymerizable composition is less than 1 wt % in terms of active components, the shrinkage on curing of the polymerizable composition is not suppressed and the adhesion is reduced. Also, Component B tends to be insolubilized, thereby reducing the transparency of the polymerizable composition and the antifouling film 1. When the Component C content in the polymerizable composition is more than 14 wt % in terms of active components, the crosslinking density of the polymer layer 3 is significantly low (the glass transition temperature is significantly high) to reduce the rubbing resistance. Furthermore, the antifouling properties decrease as the number of die transfer times increases. In the case where the polymerizable composition contains a plurality of Components C, the total of Component C contents in terms of active components should fall within the above range.

Examples of Component C include N,N-dimethylacrylamide, N-acryloylmorpholine, N,N-diethylacrylamide, N-(2-hydroxyethyl)acrylamide, diacetone acrylamide, and N-n-butoxymethylacrylamide.

Known examples of the N,N-dimethylacrylamide include “DMAA®” from KJ Chemicals Corp. Known examples of the N-acryloylmorpholine include “ACMO®” from KJ Chemicals Corp. Known examples of the N,N-diethylacrylamide include “DEAR®” from KJ Chemicals Corp. Known examples of the N-(2-hydroxyethyl)acrylamide include “HEAR®” from KJ Chemicals Corp. Known examples of the diacetone acrylamide include “DRAM®” from Nippon Kasei Chemical Co., Ltd. Known examples of the N-n-butoxymethylacrylamide include “NBMA” from MCC Unitec Co., Ltd.

Component C preferably includes N,N-dimethyl acrylamide. N,N-dimethyl acrylamide is a compound with a relatively low viscosity among monofunctional amide monomers. Thus, Component C including N,N-dimethyl acrylamide can sufficiently increase the compatibility with Components A and B.

Component C preferably includes N-acryloyl morpholine. N-acryloyl morpholine is a compound with a relatively high viscosity and a relatively high polarity among monofunctional amide monomers. Thus, Component C including N-acryloyl morpholine tends to be incompatible with the release treatment agent (e.g., fluorine-based material (having a low polarity)) for the die, whereby the release treatment agent is less likely to separate from the die even when the number of die transfer times increases, whereby a reduction in releasing properties is sufficiently suppressed.

The polymerizable composition may further contain a polymerization initiator. Thereby, the curability of the polymerizable composition increases.

Examples of the polymerization initiator include photopolymerization initiators and thermal polymerization initiators, with the photopolymerization initiators preferred. A photopolymerization initiator is active to active energy rays, and is added to initiate the polymerization reaction that polymerizes monomers.

Examples of the photopolymerization initiator include radical polymerization initiators, anionic polymerization initiators, and cationic polymerization initiators. Examples of such a photopolymerization initiator include acetophenones such as p-tert-butyltrichloroacetophenone, 2,2′-diethoxyacetophenone, and 2-hydroxy-2-methyl-1-phenylpropan-1-one; ketones such as benzophenone, 4,4′-bisdimethylaminobenzophenone, 2-chlorothioxanthone, 2-methylthioxanthone, 2-ethylthioxanthone, and 2-isopropylthioxanthone; benzoin ethers such as benzoin, benzoin methyl ether, benzoin isopropyl ether, and benzoin isobutyl ether; benzyl ketals such as benzyl dimethyl ketal and hydroxycyclohexyl phenyl ketone; acylphosphine oxides such as 2,4,6-trimethylbenzoyl-diphenyl-phosphine oxide and bis(2,4,6-trimethylbenzoyl)-phenylphosphine oxide; and alkylphenones such as 1-hydroxy-cyclohexyl-phenyl-ketone.

Known examples of the 2,4,6-trimethylbenzoyl-diphenyl-phosphine oxide include “LUCIRIN® TPO” and “IRGACURE® TPO” from IGM Resins. Known examples of the bis(2,4,6-trimethylbenzoyl)-phenylphosphine oxide include “IRGACURE 819” from IGM Resins. Known examples of the 1-hydroxy-cyclohexyl-phenyl-ketone include “IRGACURE 184” from IGM Resins.

The polymerizable composition may further contain a solvent (component other than active components). In this case, the solvent may be present in each of Components A to C together with active components, or may be contained separately from Components A to C.

Examples of the solvent include alcohols (C1-C10 ones such as methanol, ethanol, n- or i-propanol, n-, sec-, or, t-butanol, benzyl alcohol, and octanol), ketones (C3-C8 ones such as acetone, methyl ethyl ketone, methyl isobutyl ketone, diisobutyl ketone, dibutyl ketone, and cyclohexane), esters or ether esters (C4-C10 ones such as ethyl acetate, butyl acetate, and ethyl lactate), γ-butyrolactone, ethylene glycol monomethyl acetate, propylene glycol monomethyl acetate, ethers (C4-C10 ones such as EG monomethyl ether (methyl cellosolve), EG monomethyl ether (ethyl cellosolve), diethylene glycol monobutyl ether (butyl cellosolve), and propylene glycol monomethyl ether), aromatic hydrocarbons (C6-C10 ones such as benzene, toluene, and xylene), amides (C3-C10 ones such as dimethylformamide, dimethylacetamide, and N-methylpyrrolidone), halogenated hydrocarbons (C1-C2 ones such as methylene dichloride and ethylene dichloride), and petroleum-based solvents (e.g., petroleum ether, petroleum naphtha).

The bottom temperature at which the storage elastic modulus E′ of the polymer layer 3 is minimum (hereinafter, also simply referred to as bottom temperature) is 90° C. to 150° C. and the minimum storage elastic modulus E′ of the polymer layer 3 is 0.9×10⁸ to 4.5×10⁸ Pa, in a dynamic viscoelasticity measurement within a measurement temperature range of −50° C. to 250° C. and at a temperature increasing rate of 5° C./min and a frequency of 10 Hz. This can achieve excellent rubbing resistance even when the polymerizable composition contains Component C.

The relation between the rubbing resistance and the bottom temperature and minimum storage modulus E′ of the polymer layer 3 is described below with reference to FIG. 3. FIG. 3 includes plan images each showing the state of the surface of the polymer layer of the antifouling film after rubbing; FIG. 3(a) shows the case where the bottom temperature and minimum storage modulus E′ of the polymer layer each fall within an appropriate range; FIG. 3(b) shows the case where the minimum storage modulus E′ of the polymer layer is lower than that in FIG. 3(a), and FIG. 3(c) shows the case where one or both of the bottom temperature and the minimum storage modulus E′ of the polymer layer is higher than that in FIG. 3(a). The plan images shown in FIG. 3 were taken with a scanning electron microscope.

In the case where the polymer layer 3 (projections 4) has a low crosslinking density and is soft and the surface (the surface remote from the substrate 2) of the polymer layer 3 is rubbed, the projections 4 fall once and they never rise again as shown in FIG. 3(b). This phenomenon is clearly observed particularly when the surface (the surface remote from the substrate 2) of the polymer layer 3 is rubbed with a soft material such as nonwoven fabric. The rubbed part appears white because the part has a reflectance different from that of unrubbed part. The inventors found through studies that this phenomenon particularly correlates to the minimum storage modulus E′ of the polymer layer 3; a lower minimum value tends to cause the phenomenon.

In the case where the polymer layer 3 (projections 4) is hard and the surface (the surface remote from the substrate 2) of the polymer layer 3 is rubbed, the projections 4 are less likely to fall and are thereby less likely to rise again as shown in FIG. 3(c). This phenomenon is clearly observed particularly when the surface (the surface remote from the substrate 2) of the polymer layer 3 is rubbed with a hard material such as steel wool. The rubbed part tends to have scratches. The inventors found through studies that this phenomenon particularly correlates to the bottom temperature of the polymer layer 3; a higher bottom temperature tends to cause the phenomenon.

In contrast, since the bottom temperature and minimum storage modulus E′ of the polymer layer 3 each fall within the appropriate range in the present embodiment, the polymer layer 3 (projections 4) has an appropriate elasticity. Thus, when the surface (the surface remote from the substrate 2) of the polymer layer 3 is rubbed, the projections 4 fall once and then rise again as shown in FIG. 3(a). In other words, the present embodiment can achieve excellent rubbing resistance. Here, in the case where the minimum storage modulus E′ of the polymer layer 3 falls within an appropriate range but the bottom temperature is higher than that in FIG. 3(a), the bottom temperature is significantly apart from the environmental temperature at which the surface (the surface remote from the substrate 2) of the polymer layer 3 is rubbed and the polymer layer 3 (projections 4) is very hard. Accordingly, the projections 4 fail to rise again as shown in FIG. 3(c).

The rubbing resistance is assumed to correlate to the crosslinking density and glass transition temperature (Tg) of the polymer layer 3. However, studies made by the present inventors have found that the rubbing resistance correlates better with the bottom temperature and minimum storage modulus E′ of the polymer layer 3, presumably for the following reason. The crosslinking density is a value calculated from the formula: n =E′/3RT (n: crosslinking density; E′: storage modulus; R: gas constant; T: absolute temperature). The glass transition temperature is a value (temperature) corresponding to the peak in a graph showing the temperature dependence represented by tan δ=E″/E′ (E′: storage modulus; E″: loss modulus). In other words, the crosslinking density and the glass transition temperature are values obtained indirectly using values such as storage modulus E′. In contrast, the bottom temperature and the minimum storage modulus E′ are values obtained directly from a graph showing the temperature dependence of the storage modulus E′. For this reason, rising of fine protrusions (rubbing resistance) such as the projections 4 of the polymer layer 3 is considered to correlate better with the bottom temperature and the minimum storage modulus E′.

The bottom temperature of the polymer layer 3 is 90° C. to 150° C., preferably 95° C. to 140° C., more preferably 100° C. to 130° C., in a dynamic viscoelasticity measurement within a measurement temperature range of −50° C. to 250° C. and at a temperature increasing rate of 5° C./min and a frequency of 10 Hz. A bottom temperature of the polymer layer 3 of higher than 150° C. causes the polymer layer 3 to have significantly high hardness (to be brittle), resulting in reduced rubbing resistance. In this case, when the surface (the surface remote from the substrate 2) of the polymer layer 3 is rubbed with a hard material such as steel wool, the rubbed part tends to have scratches. A bottom temperature of the polymer layer 3 of lower than 90° C. is close to the environmental temperature at which the surface (the surface remote from the substrate 2) of the polymer layer 3 is rubbed, whereby the projections 4 tend to fuse into each other. Therefore, when the surface (the surface remote from the substrate 2) of the polymer layer 3 is rubbed with a soft material such as nonwoven fabric, the projections 4 do not rise and the rubbed part appears white because the part has a reflectance different from that of unrubbed part.

The minimum storage modulus E′ of the polymer layer 3 is 0.9×10⁸ to 4.5×10⁸ Pa, preferably 1.0×10⁸ to 4.0×10⁸ Pa, more preferably 1.1×10⁸ to 3.5×10⁸ Pa in a dynamic viscoelasticity measurement within a measurement temperature range of −50° C. to 250° C. and at a temperature increasing rate of 5° C./min and a frequency of 10 Hz. A minimum storage modulus E′ of the polymer layer 3 of lower than 0.9×10⁸ Pa causes the polymer layer 3 to have a low crosslinking density and thereby to have a significantly low hardness, resulting in reduced rubbing resistance. In this case, when the surface (the surface remote from the substrate 2) of the polymer layer 3 is rubbed with a soft material such as nonwoven fabric, the rubbed part appears white because the part has a reflectance different from that of unrubbed part. A minimum storage modulus E′ of the polymer layer 3 of higher than 4.5×10⁸ Pa causes the polymer layer 3 to have a significantly high crosslinking density (to be brittle), resulting in reduced rubbing resistance. In this case, when the surface (the surface remote from the substrate 2) of the polymer layer 3 is rubbed with a hard material such as steel wool, the rubbed part tends to have scratches.

The bottom temperature and minimum storage modulus E′ of the polymer layer 3 may be adjusted by the component proportions (particularly, Component A) in the polymerizable composition.

In terms of the antifouling properties, the polymer layer 3 preferably has a surface (the surface remote from the substrate 2) that shows a contact angle of 130° or greater with water and a contact angle of 30° or greater with hexadecane.

The antifouling film 1 may be used in any way that utilizes the excellent antifouling properties of the antifouling film 1, and may be used as, for example, an optical film such as an antireflective film. Such an antireflective film contributes to an increase in visibility when it is mounted inside or outside a display device.

The antifouling properties of the antifouling film 1 may mean that dirt adhering to the surface (the surface remote from the substrate 2) of the polymer layer 3 is easily removable, or that dirt is not likely to adhere to the surface (the surface remote from the substrate 2) of the polymer layer 3. The antifouling film 1, owing to its moth-eye structure, can achieve better antifouling properties than a conventional antifouling film (e.g., fluorine-containing film) having a normal surface such as a flat surface.

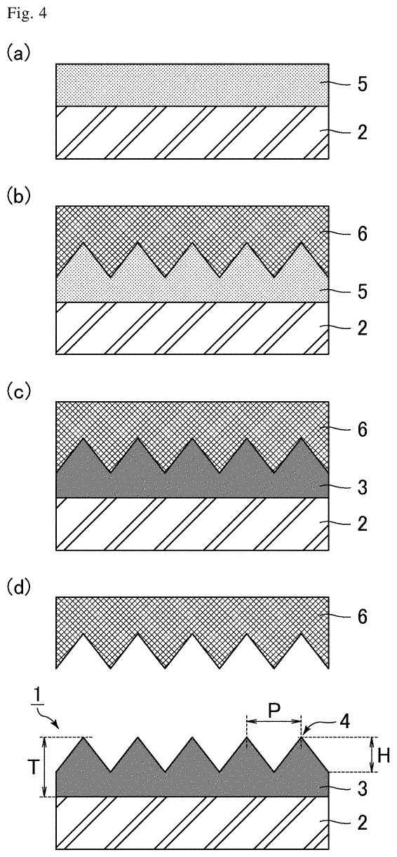

The antifouling film 1 can be produced by, for example, the following production method. FIG. 4 includes schematic cross-sectional views illustrating an exemplary method for producing the antifouling film of the embodiment.

### (Process 1)

As shown in FIG. 4(a), a polymerizable composition 5 is applied to a surface of the substrate 2.

Examples of techniques of applying the polymerizable composition 5 include spray coating, gravure coating, slot-die coating, and bar coating. For application of the polymerizable composition 5, gravure coating or slot-die coating is preferred in order to level the thickness of the resulting film and to achieve good productivity.

The polymerizable composition 5 contains the above proportions of at least Components A to C. When the polymerizable composition 5 further contains a solvent (component other than active components), heating (drying) may be performed to remove the solvent after application of the polymerizable composition 5. The heating is preferably performed at a temperature equal to or higher than the boiling point of the solvent.

### (Process 2)

As shown in FIG. 4(b), the substrate 2 is pushed to a die 6 with the polymerizable composition 5 in between. As a result, an uneven structure is formed on a surface (the surface remote from the substrate 2) of the polymerizable composition 5.

### (Process 3)

The polymerizable composition 5 having an uneven structure on the surface is cured. As a result, as shown in FIG. 4(c), the polymer layer 3 is formed.

Curing of the polymerizable composition 5 is achieved by, for example, application of active energy rays or heating, preferably by application of active energy rays, more preferably by application of ultraviolet rays. Application of active energy rays may be performed from the substrate 2 side of the polymerizable composition 5, or may be performed from the die 6 side of the polymerizable composition 5. Application of active energy rays may be performed once or may be performed multiple times. Curing of the polymerizable composition 5 (Process 3) may be performed simultaneously with the aforementioned formation of the uneven structure of the polymerizable composition 5 (Process 2).

### (Process 4)

As shown in FIG. 4(d), the die 6 is released from the polymer layer 3. As a result, the antifouling film 1 is completed.

In the aforementioned exemplary production method, Processes 1 to 4 can be continuously and efficiently performed if the substrate 2 is in the form of a roll, for example.

The present exemplary production includes as Processes 1 and 2 a process of applying the polymerizable composition 5 to the surface of the substrate 2 and then pushing the substrate 2 to the die 6 with the polymerizable composition 5 in between. Yet, the method may include a process of applying the polymerizable composition 5 to the surface of the die 6, and then pushing the substrate 2 to the die 6 with the polymerizable composition 5 in between. A series of processes such as Processes 1 to 4 is also referred to as “die transfer”.

The die 6 may be one produced by the following method. First, a film of aluminum as a material of the die 6 is formed on a surface of a support by sputtering. Next, the resulting aluminum layer is repetitively subjected to anodizing and etching. Thereby, a cavity (die 6) of the moth-eye structure can be produced. At this time, the uneven structure of the die 6 can be modified by adjusting the duration of the anodizing and the duration of the etching.

Examples of the material of the support include glass; metals such as stainless steel and nickel; polyolefinic resins such as polypropylene, polymethylpentene, and cyclic olefinic polymers (typified by norbornene-based resin, e.g., “Zeonor®” from Zeon Corp., “Arton®” from JSR Corp.); polycarbonate resin; and resins such as polyethylene terephthalate, polyethylene naphthalate, and triacetyl cellulose. Instead of the support with an aluminum film formed on the surface, an aluminum support may be used.

The die 6 may be in a form of a flat plate or a roll, for example.

The surface of the die 6 preferably has undergone release treatment. Thereby, the die 6 can be easily removed from the polymer layer 3. Further, this treatment makes the surface free energy of the die 6 low, and thus the active components in Component B can uniformly be distributed on the surface (the surface remote from the substrate 2) of the polymerizable composition 5 when the substrate 2 is pushed to the die 6 in Process 2. Further, this treatment can prevent early removal of the active components in Component B from the surface (the surface remote from the substrate 2) of the polymerizable composition 5 before curing of the polymerizable composition 5. As a result, in the antifouling film 1, the active components in Component B can uniformly be distributed on the surface (the surface remote from the substrate 2) of the polymer layer 3. As described above, the amount of Component C is minimized in the present embodiment. Accordingly, with the die 6 having a surface after release treatment, the releasing properties of the polymer layer 3 and the die 6 are maintained even when the number of die 6 transfer times increases, which can suppress a reduction in antifouling properties.

Examples of the material (release treatment agent) used for release treatment of the die 6 include fluorine-based materials, silicone-based materials, and phosphate-ester-based materials. Known examples of the fluorine-based materials include “Optool DSX” and “Optool AES4” from Daikin Industries, Ltd.

### EXAMPLES AND COMPARATIVE EXAMPLES

The present invention is described in more detail based on the following examples and comparative examples. The examples, however, are not intended to limit the scope of the present invention.

The materials used in production of the antifouling films in the examples and comparative examples were as follows.

### <Substrate>

“TAC-TD80U” from Fujifilm Corp. was used. The thickness thereof was 80 μm.

### <Die>

A die produced by the following method was used. First, a film of aluminum as a material of the die was formed on a 10-cm-square glass substrate by sputtering. The thickness of the resulting aluminum layer was 1.0 μm. Next, the resulting aluminum layer was repetitively subjected to anodizing and etching. Thereby, an anodized layer was formed with many fine pores (distance between the bottom points of adjacent pores (recesses) was not longer than the wavelength of visible light). Specifically, anodizing, etching, anodizing, etching, anodizing, etching, anodizing, etching, and anodizing were performed in the stated order (anodizing: 5 times, etching: 4 times), so that many fine pores (recesses) were formed each tapering toward the inside of the aluminum layer (a tapered shape). As a result, a die having an uneven structure was obtained. The anodizing was performed using oxalic acid (concentration: 0.03 wt %) at a liquid temperature of 5° C. and an applied voltage of 80 V. The duration of a single anodizing process was 25 seconds. The etching was performed using phosphoric acid (concentration: 1 mol/l) at a liquid temperature of 30° C. The duration of a single etching process was 25 minutes. The die was found to have a recess depth of 290 nm by scanning electron microscopic observation. The surface of the die was subjected to release treatment with “Optool AES4” from Daikin Industries, Ltd. in advance.

### <Polymerizable Composition>

Polymerizable compositions R1 to R23 and r1 to r20 formed from the materials shown in Tables 1 to 9 were used. The values in Tables 1 to 9 are each the component content (unit: parts by weight) in the composition. The abbreviations of the respective components are as follows.

(Polyfunctional acrylate)
“U-10”

“U-10HA” from Shin Nakamura Chemical Co., Ltd.

The number of functional groups: 10

The number of ethylene oxide groups: 0 (not contained)

Active components: 100 wt %
“A-PG5027E”

“NK Economer A-PG5027E” from Shin-Nakamura Chemical Co., Ltd.

The number of functional groups: 9

The number of ethylene oxide groups: 27 for each molecule

Active components: 100 wt %
“UX-5000”

“Kayarad UX-5000” from Nippon Kayaku Co., Ltd.

The number of functional groups: 6

The number of ethylene oxide groups: 0 (not contained)

Active components: 100 wt %
“DPCA-60”

“Kayarad DPCA-60” from Nippon Kayaku Co., Ltd.

The number of functional groups: 6

The number of ethylene oxide groups: 0 (not contained)

Active components: 100 wt %
“DPEA-12”

“Kayarad DPEA-12” from Nippon Kayaku Co., Ltd.

The number of functional groups: 6

The number of ethylene oxide groups: 12 for each molecule

Active components: 100 wt %
“ATM-35E”

“NK Ester ATM-35E” from Shin-Nakamura Chemical Co., Ltd.

The number of functional groups: 4

The number of ethylene oxide groups: 35 for each molecule

Active components: 100 wt %
“ATM-4PL”

“NK Ester ATM-4PL” from Shin-Nakamura Chemical Co., Ltd.

The number of functional groups: 4

The number of ethylene oxide groups: 0 (not contained)

Active components: 100 wt %
“SR351NS”

“SR351NS” from Arkema K.K.

The number of functional groups: 3

The number of ethylene oxide groups: 0 (not contained)

Active components: 100 wt %
“SR499NS”

“SR499NS” from Arkema K.K.

The number of functional groups: 3

The number of ethylene oxide groups: 6 for each molecule

Active components: 100 wt %
“A-GLY-3E”

“NK Ester A-GLY-3E” from Shin-Nakamura Chemical Co., Ltd.

The number of functional groups: 3

The number of ethylene oxide groups: 3 for each molecule

Active components: 100 wt %
“VE”

“VEEA” from Nippon Shokubai Co., Ltd.

The number of functional groups: 2

The number of ethylene oxide groups: 2 for each molecule

Active components: 100 wt %
“PE-300”

“New Frontier PE-300” from DKS Co., Ltd.

The number of functional groups: 2

The number of ethylene oxide groups: 6 for each molecule

Active components: 100 wt %
“SR344”

“SR344” from Arkema K.K.

The number of functional groups: 2

The number of ethylene oxide groups: 9 for each molecule

Active components: 100 wt %
“APG-400”

“NK Ester APG-400” from Shin-Nakamura Chemical Co., Ltd.

The number of functional groups: 2

The number of ethylene oxide groups: 0 (not contained)

Active components: 100 wt %
“APG-700”

“NK Ester APG-700” from Shin-Nakamura Chemical Co., Ltd.

The number of functional groups: 2

The number of ethylene oxide groups: 0 (not contained)

Active components: 100 wt %

(Release agent)
“MT70 ”

“Fomblin MT70” (first fluorine-based release agent) from Solvay

Perfluoro polyether group: present

Perfluoro alkyl group: absent

Active components: 80 wt % (perfluoro polyether derivative)

Solvent: 20 wt % (methyl ethyl ketone)
“RS-76-NS”

“Megaface RS-76-NS” (second fluorine-based release agent) from DIC Corporation

Perfluoro polyether group: absent

Perfluoro alkyl group: present

Active components: 100 wt % (fluorine-containing oligomer (20 wt %) and dipropylene glyreol diacrylate (80 wt %))
“FAAC-6”

“Cheminox FAAC-6” (second fluorine-based release agent) from Unimatec Corporation

Perfluoro polyether group: absent

Perfluoro alkyl group: present

Active components: 100 wt %
“FAAC-4”

“Cheminox FAAC-4” (second fluorine-based release agent) from Unimatec Corporation

Perfluoro polyether group: absent

Perfluoro alkyl group: present

Active components: 100 wt %
“UV3576”

“BYK®-UV3576” (silicon-based release agent) from BYK Japan KK

Active components: 100 wt % (acryl group-containing dimethyl polysiloxane polymer (50 wt %) and tripropylene glycol diacrylate (50 wt %))

### (Monofunctional Amide Monomer)

“DM”

“DMAA” from KJ Chemicals Corporation

Active components: 100 wt %
“DE”

“DEAA” from KJ Chemicals Corporation

Active components: 100 wt %
“AC”

“ACMO” from KJ Chemicals Corporation

Active components: 100 wt %

### (Polymerization Initiator)

“TPO”

“Lucirin TPO” from IGM Resins

Active components: 100 wt %
“819”

“Irgacure 819” from IGM Resins

Active components: 100 wt %
“184”

“Irgacure 184” from IGM Resins

Active components: 100 wt %

TABLE 1

| | | | Polymerizable composition | | | | |
|---|---|---|---|---|---|---|---|
| Component | Category | Abbreviation | R1 | R2 | R3 | R4 | R5 |
| Polyfunctional | Component A | U-10 | 7.2 | 7.2 | 14.6 | — | — |
| acrylate | | A-PG5027E | — | — | — | — | 14.4 |
| | | UX-5000 | — | — | — | — | — |
| | | DPCA-60 | — | — | — | — | — |
| | | DPEA-12 | — | — | — | — | — |
| | | ATM-35E | — | — | — | — | — |
| | | ATM-4PL | — | — | — | — | — |
| | | SR351NS | 7.2 | 7.2 | — | 14.4 | — |
| | | SR499NS | — | — | — | — | — |
| | | A-GLY-3E | — | — | — | — | — |
| | | VE | 40.9 | 45.7 | 46.3 | 31.3 | 45.7 |
| | | PE-300 | — | — | — | — | — |
| | | SR344 | 38.5 | 33.7 | 34.2 | 48.1 | 33.7 |
| | | APG-400 | — | — | — | — | — |
| | | APG-700 | — | — | — | — | — |
| Release agent | Component B | MT70 | 2.375 | 2.375 | 2.5 | 2.375 | 2.375 |
| | | RS-76-NS | — | — | — | — | — |
| | | FAAC-6 | — | — | — | — | — |
| | | FAAC-4 | — | — | — | — | — |
| | — | UV3576 | — | — | — | — | — |
| Monofunctional amide | Component C | DM | 2.4 | 2.4 | 2.4 | 2.4 | 2.4 |
| monomer | | DE | — | — | — | — | — |
| | | AC | — | — | — | — | — |
| Polymerization | — | TPO | 1.9 | 1.9 | 0.5 | 1.9 | 1.9 |
| initiator | | 819 | — | — | — | — | — |
| | | 184 | — | — | — | — | — |

TABLE 2

| | | | Polymerizable composition | | | | |
|---|---|---|---|---|---|---|---|
| Component | Category | Abbreviation | R6 | R7 | R8 | R9 | R10 |
| Polyfunctional | Component A | U-10 | 14.4 | 14.4 | 23.6 | — | — |
| acrylate | | A-PG5027E | — | — | — | — | — |
| | | UX-5000 | — | — | — | — | — |
| | | DPCA-60 | — | — | — | — | 23.6 |
| | | DPEA-12 | — | — | — | 23.6 | — |
| | | ATM-35E | — | — | — | — | — |
| | | ATM-4PL | — | — | — | — | — |
| | | SR351NS | — | — | — | 14.4 | 15.4 |
| | | SR499NS | — | — | — | — | — |
| | | A-GLY-3E | — | — | — | — | — |
| | | VE | 48.1 | 48.1 | — | — | — |
| | | PE-300 | — | — | — | — | — |
| | | SR344 | 32.2 | 32.7 | 65.4 | 48.6 | 43.7 |
| | | APG-400 | — | — | — | — | — |
| | | APG-700 | — | — | — | — | — |
| Release agent | Component B | MT70 | 2.375 | 2.375 | 2.375 | 2.375 | 2.375 |
| | | RS-76-NS | — | — | — | — | — |
| | | FAAC-6 | — | — | — | — | — |
| | | FAAC-4 | — | — | — | — | — |
| | — | UV3576 | — | — | — | — | — |
| Monofunctional amide | Component C | DM | 1.5 | 1.0 | 7.2 | 9.6 | 13.5 |
| monomer | | DE | — | — | — | — | — |
| | | AC | — | — | — | — | — |
| Polymerization | — | TPO | 1.9 | 1.9 | 1.9 | 1.9 | 1.9 |
| initiator | | 819 | — | — | — | — | — |
| | | 184 | — | — | — | — | — |

TABLE 3

| | | | Polymerizable composition | | | | |
|---|---|---|---|---|---|---|---|
| Component | Category | Abbreviation | R11 | R12 | R13 | R14 | R15 |
| Polyfunctional | Component A | U-10 | — | — | — | — | 30.4 |
| acrylate | | A-PG5027E | — | — | — | — | — |
| | | UX-5000 | — | — | — | — | — |
| | | DPCA-60 | — | — | — | — | — |
| | | DPEA-12 | — | 23.6 | — | 23.6 | — |
| | | ATM-35E | — | — | — | — | 54.9 |
| | | ATM-4PL | 28.4 | — | 28.4 | — | — |
| | | SR351NS | 9.6 | — | 9.6 | — | — |
| | | SR499NS | — | 24.0 | — | — | — |
| | | A-GLY-3E | — | — | — | 24.0 | — |
| | | VE | — | — | — | — | — |
| | | PE-300 | — | — | — | — | — |
| | | SR344 | 48.6 | 39.0 | 48.6 | 39.0 | — |
| | | APG-400 | — | — | — | — | — |
| | | APG-700 | — | — | — | — | — |
| Release agent | Component B | MT70 | 2.375 | 2.375 | 2.375 | 2.375 | — |
| | | RS-76-NS | — | — | — | — | 4.7 |
| | | FAAC-6 | — | — | — | — | — |
| | | FAAC-4 | — | — | — | — | — |
| | — | UV3576 | — | — | — | — | — |
| Monofunctional amide | Component C | DM | 9.6 | 9.6 | 9.6 | 9.6 | 9.5 |
| monomer | | DE | — | — | — | — | — |
| | | AC | — | — | — | — | — |
| Polymerization | — | TPO | 1.9 | 1.9 | 0.634 | 1.9 | 0.5 |
| initiator | | 819 | — | — | 0.633 | — | — |
| | | 184 | — | — | 0.633 | — | — |

TABLE 4

| | | | Polymerizable composition | | | |
|---|---|---|---|---|---|---|
| Component | Category | Abbreviation | R16 | R17 | R18 | R19 |
| Polyfunctional | Component A | U-10 | 7.2 | 7.2 | 23.6 | 23.0 |
| acrylate | | A-PG5027E | — | — | — | — |
| | | UX-5000 | — | — | — | — |
| | | DPCA-60 | — | — | — | — |
| | | DPEA-12 | — | — | — | — |
| | | ATM-35E | — | — | — | — |
| | | ATM-4PL | — | — | — | — |
| | | SR351NS | 7.2 | 7.2 | — | — |
| | | SR499NS | — | — | — | — |
| | | A-GLY-3E | — | — | — | — |
| | | VE | 42.3 | 37.3 | — | — |
| | | PE-300 | — | — | — | — |
| | | SR344 | 38.5 | 34.5 | 65.4 | 64.1 |
| | | APG-400 | — | — | — | — |
| | | APG-700 | — | — | — | — |
| Release agent | Component B | MT70 | 0.625 | 11.875 | — | 2.375 |
| | | RS-76-NS | — | — | — | — |
| | | FAAC-6 | — | — | 1.9 | 1.9 |
| | | FAAC-4 | — | — | — | — |
| | — | UV3576 | — | — | — | — |
| Monofunctional amide | Component C | DM | 2.4 | 2.4 | 7.2 | 7.2 |
| monomer | | DE | — | — | — | — |
| | | AC | — | — | — | — |
| Polymerization | — | TPO | 1.9 | 1.9 | 1.9 | 1.9 |
| initiator | | 819 | — | — | — | — |
| | | 184 | — | — | — | — |

TABLE 5

| | | | Polymerizable composition | | | |
|---|---|---|---|---|---|---|
| Component | Category | Abbreviation | R20 | R21 | R22 | R23 |
| Polyfunctional | Component A | U-10 | 23.0 | 23.6 | 23.6 | — |
| acrylate | | A-PG5027E | — | — | — | — |
| | | UX-5000 | — | — | — | — |
| | | DPCA-60 | — | — | — | — |
| | | DPEA-12 | — | — | — | 23.6 |
| | | ATM-35E | — | — | — | — |
| | | ATM-4PL | — | — | — | — |
| | | SR351NS | — | — | — | 9.6 |
| | | SR499NS | — | — | — | — |
| | | A-GLY-3E | — | — | — | — |
| | | VE | — | — | — | — |
| | | PE-300 | — | — | — | 53.4 |
| | | SR344 | 64.1 | 65.4 | 65.4 | — |
| | | APG-400 | — | — | — | — |
| | | APG-700 | — | — | — | — |
| Release agent | Component B | MT70 | 2.375 | 2.375 | 2.375 | 2.375 |
| | | RS-76-NS | — | — | — | — |
| | | FAAC-6 | — | — | — | — |
| | | FAAC-4 | 1.9 | — | — | — |
| | — | UV3576 | — | — | — | — |
| Monofunctional amide | Component C | DM | 7.2 | — | — | 9.6 |
| monomer | | DE | — | 7.2 | — | — |
| | | AC | — | — | 7.2 | — |
| Polymerization | — | TPO | 1.9 | 1.9 | 1.9 | 1.9 |
| initiator | | 819 | — | — | — | — |
| | | 184 | — | — | — | — |

TABLE 6

| | | | Polymerizable composition | | | | |
|---|---|---|---|---|---|---|---|
| Component | Category | Abbreviation | r1 | r2 | r3 | r4 | r5 |
| Polyfunctional | Component A | U-10 | 14.4 | 33.8 | — | 23.6 | 15.0 |
| acrylate | | A-PG5027E | — | — | — | — | — |
| | | UX-5000 | — | — | — | — | — |
| | | DPCA-60 | — | — | — | — | — |
| | | DPEA-12 | — | — | — | — | — |
| | | ATM-35E | — | 61.0 | — | — | — |
| | | ATM-4PL | — | — | 23.6 | — | — |
| | | SR351NS | — | — | 14.4 | — | — |
| | | SR499NS | — | — | — | — | — |
| | | A-GLY-3E | — | — | — | — | — |
| | | VE | 48.1 | — | — | — | — |
| | | PE-300 | — | — | — | — | — |
| | | SR344 | 33.2 | — | 43.8 | 58.2 | 66.8 |
| | | APG-400 | — | — | — | — | — |
| | | APG-700 | — | — | — | — | — |
| Release agent | Component B | MT70 | 2.375 | — | 2.375 | 2.375 | 2.375 |
| | | RS-76-NS | — | 4.7 | — | — | — |
| | | FAAC-6 | — | — | — | — | — |
| | | FAAC-4 | — | — | — | — | — |
| | — | UV3576 | — | — | — | — | — |
| Monofunctional amide | Component C | DM | 0.5 | — | 14.4 | 14.4 | 14.4 |
| monomer | | DE | — | — | — | — | — |
| | | AC | — | — | — | — | — |
| Polymerization | — | TPO | 1.9 | 0.5 | 1.9 | 1.9 | 1.9 |
| initiator | | 819 | — | — | — | — | — |
| | | 184 | — | — | — | — | — |

TABLE 7

| | | | Polymerizable composition | | | | |
|---|---|---|---|---|---|---|---|
| Component | Category | Abbreviation | r6 | r7 | r8 | r9 | r10 |
| Polyfunctional | Component A | U-10 | 23.6 | — | 23.6 | 13.2 | — |
| acrylate | | A-PG5027E | — | — | — | — | — |
| | | UX-5000 | — | 25.4 | — | — | — |
| | | DPCA-60 | — | — | — | — | — |
| | | DPEA-12 | — | — | — | — | 77.7 |
| | | ATM-35E | — | 45.7 | — | — | — |
| | | ATM-4PL | — | — | — | — | — |
| | | SR351NS | — | — | 9.6 | — | — |
| | | SR499NS | — | — | — | — | — |
| | | A-GLY-3E | — | — | — | — | — |
| | | VE | — | — | — | — | — |
| | | PE-300 | — | — | — | — | — |
| | | SR344 | 39.0 | — | 43.8 | 35.0 | — |
| | | APG-400 | 16.8 | — | — | — | — |
| | | APG-700 | — | — | — | 28.8 | — |
| Release agent | Component B | MT70 | 2.375 | — | 2.375 | 2.375 | 1.25 |
| | | RS-76-NS | — | 4.7 | — | — | — |
| | | FAAC-6 | — | — | — | — | — |
| | | FAAC-4 | — | — | — | — | — |
| | — | UV3576 | — | — | — | — | — |
| Monofunctional amide | Component C | DM | 16.8 | 23.7 | 19.2 | 19.2 | 19.4 |
| monomer | | DE | — | — | — | — | — |
| | | AC | — | — | — | — | — |
| Polymerization | — | TPO | 1.9 | 0.5 | 1.9 | 1.9 | 1.9 |
| initiator | | 819 | — | — | — | — | — |
| | | 184 | — | — | — | — | — |

TABLE 8

| | | | Polymerizable composition | | | | |
|---|---|---|---|---|---|---|---|
| Component | Category | Abbreviation | r11 | r12 | r13 | r14 | r15 |
| Polyfunctional | Component A | U-10 | 35.5 | 27.1 | 23.6 | 23.6 | — |
| acrylate | | A-PG5027E | 35.5 | — | — | — | — |
| | | UX-5000 | — | — | — | — | — |
| | | DPCA-60 | — | — | — | — | — |
| | | DPEA-12 | — | — | — | — | — |
| | | ATM-35E | — | 48.7 | — | — | — |
| | | ATM-4PL | — | — | — | — | — |
| | | SR351NS | — | — | 18.8 | 11.1 | 9.6 |
| | | SR499NS | — | — | — | — | 33.7 |
| | | A-GLY-3E | — | — | — | — | — |
| | | VE | — | — | — | — | — |
| | | PE-300 | — | — | — | 51.9 | — |
| | | SR344 | — | — | 46.6 | — | 43.3 |
| | | APG-400 | — | — | — | — | — |
| | | APG-700 | — | — | — | — | — |
| Release agent | Component B | MT70 | — | — | 2.375 | 2.375 | 2.375 |
| | | RS-76-NS | 4.7 | 4.7 | — | — | — |
| | | FAAC-6 | — | — | — | — | — |
| | | FAAC-4 | — | — | — | — | — |
| | — | UV3576 | — | — | — | — | — |
| Monofunctional amide | Component C | DM | 23.8 | 19.0 | 7.2 | 9.6 | 9.6 |
| monomer | | DE | — | — | — | — | — |
| | | AC | — | — | — | — | — |
| Polymerization | — | TPO | 0.5 | 0.5 | 1.9 | 1.9 | 1.9 |
| initiator | | 819 | — | — | — | — | — |
| | | 184 | — | — | — | — | — |

TABLE 9

| | | | Polymerizable composition | | | | |
|---|---|---|---|---|---|---|---|
| Component | Category | Abbreviation | r16 | r17 | r18 | r19 | r20 |
| Polyfunctional | Component A | U-10 | 7.2 | 7.2 | — | 27.1 | 23.1 |
| acrylate | | A-PG5027E | — | — | 77.0 | 49.7 | — |
| | | UX-5000 | — | — | — | — | — |
| | | DPCA-60 | — | — | — | — | — |
| | | DPEA-12 | — | — | — | — | — |
| | | ATM-35E | — | — | — | — | — |
| | | ATM-4PL | — | — | — | — | — |
| | | SR351NS | 7.2 | 7.2 | — | — | — |
| | | SR499NS | — | — | — | — | — |
| | | A-GLY-3E | — | — | — | — | — |
| | | VE | 42.8 | 35.3 | — | — | — |
| | | PE-300 | — | — | — | — | — |
| | | SR344 | 38.5 | 34.5 | — | — | 64.1 |
| | | APG-400 | — | — | — | — | — |
| | | APG-700 | — | — | — | — | — |
| Release agent | Component B | MT70 | — | 14.375 | 2.375 | 2.375 | — |
| | | RS-76-NS | — | — | — | — | — |
| | | FAAC-6 | — | — | — | — | — |
| | | FAAC-4 | — | — | — | — | — |
| | — | UV3576 | — | — | — | — | 3.8 |
| Monofunctional amide | Component C | DM | 2.4 | 2.4 | 19.2 | 19.4 | 7.1 |
| monomer | | DE | — | — | — | — | — |
| | | AC | — | — | — | — | — |
| Polymerization | — | TPO | 1.9 | 1.9 | 1.9 | 1.9 | 1.9 |
| initiator | | 819 | — | — | — | — | — |
| | | 184 | — | — | — | — | — |

Tables 10 to 18 show the following amounts (1) and (2) in terms of active components.

(1) Components A to C contents in the polymerizable composition (in the tables, “Component A content”, “Component B content”, and “Component C content”)

(2) Amide group content derived from Component C in the polymerizable composition (in the tables, “amide group content”)

TABLE 10

| | Polymerizable composition | | | | |
|---|---|---|---|---|---|
| | R1 | R2 | R3 | R4 | R5 |
| Component A | 93.8 | 93.8 | 95.1 | 93.8 | 93.8 |
| content (wt %) | | | | | |
| Component B | 1.9 | 1.9 | 2.0 | 1.9 | 1.9 |
| content (wt %) | | | | | |
| Component C | 2.4 | 2.4 | 2.4 | 2.4 | 2.4 |
| content (wt %) | | | | | |
| Amide group | 0.24 | 0.24 | 0.24 | 0.24 | 0.24 |
| content (mmol/g) | | | | | |

TABLE 11

| | Polymerizable composition | | | | |
|---|---|---|---|---|---|
| | R6 | R7 | R8 | R9 | R10 |
| Component A | 94.7 | 95.2 | 89.0 | 86.6 | 82.7 |
| content (wt %) | | | | | |
| Component B | 1.9 | 1.9 | 1.9 | 1.9 | 1.9 |
| content (wt %) | | | | | |
| Component C | 1.5 | 1.0 | 7.2 | 9.6 | 13.5 |
| content (wt %) | | | | | |
| Amide group | 0.15 | 0.10 | 0.73 | 0.97 | 1.36 |
| content (mmol/g) | | | | | |

TABLE 12

| | Polymerizable composition | | | | |
|---|---|---|---|---|---|
| | R11 | R12 | R13 | R14 | R15 |
| Component A | 86.6 | 86.6 | 86.6 | 86.6 | 85.3 |
| content (wt %) | | | | | |
| Component B | 1.9 | 1.9 | 1.9 | 1.9 | 4.7 |
| content (wt %) | | | | | |
| Component C | 9.6 | 9.6 | 9.6 | 9.6 | 9.5 |
| content (wt %) | | | | | |
| Amide group | 0.97 | 0.97 | 0.97 | 0.97 | 0.96 |
| content (mmol/g) | | | | | |

TABLE 13

Polymerizable composition

| | R16 | R17 | R18 | R19 |
|---|---|---|---|---|
| Component A | 95.2 | 86.2 | 89.0 | 87.1 |
| content (wt %) | | | | |
| Component B | 0.5 | 9.5 | 1.9 | 3.8 |
| content (wt %) | | | | |
| Component C | 2.4 | 2.4 | 7.2 | 7.2 |
| content (wt %) | | | | |
| Amide group | 0.24 | 0.24 | 0.73 | 0.73 |
| content (mmol/g) | | | | |

TABLE 14

Polymerizable composition

| | R20 | R21 | R22 | R23 |
|---|---|---|---|---|
| Component A | 87.1 | 89.0 | 89.0 | 86.6 |
| content (wt %) | | | | |
| Component B | 3.8 | 1.9 | 1.9 | 1.9 |
| content (wt %) | | | | |
| Component C | 7.2 | 7.2 | 7.2 | 9.6 |
| content (wt %) | | | | |
| Amide group | 0.73 | 0.57 | 0.51 | 0.97 |
| content (mmol/g) | | | | |

TABLE 15

| | Polymerizable composition | | | | |
|---|---|---|---|---|---|
| | r1 | r2 | r3 | r4 | r5 |
| Component A | 95.7 | 94.8 | 81.8 | 81.8 | 81.8 |
| content (wt %) | | | | | |
| Component B | 1.9 | 4.7 | 1.9 | 1.9 | 1.9 |
| content (wt %) | | | | | |
| Component C | 0.5 | 0 | 14.4 | 14.4 | 14.4 |
| content (wt %) | | | | | |
| Amide group | 0.05 | 0 | 1.45 | 1.45 | 1.45 |
| content (mmol/g) | | | | | |

TABLE 16

| | Polymerizable composition | | | | |
|---|---|---|---|---|---|
| | r6 | r7 | r8 | r9 | r10 |
| Component A | 79.4 | 71.1 | 77.0 | 77.0 | 77.7 |
| content (wt %) | | | | | |
| Component B | 1.9 | 4.7 | 1.9 | 1.9 | 1.0 |
| content (wt %) | | | | | |
| Component C | 16.8 | 23.7 | 19.2 | 19.2 | 19.4 |
| content (wt %) | | | | | |
| Amide group | 1.70 | 2.39 | 1.94 | 1.94 | 1.96 |
| content (mmol/g) | | | | | |

TABLE 17

| | Polymerizable composition | | | | |
|---|---|---|---|---|---|
| | r11 | r12 | r13 | r14 | r15 |
| Component A | 71.0 | 75.8 | 89.0 | 86.6 | 86.6 |
| content (wt %) | | | | | |
| Component B | 4.7 | 4.7 | 1.9 | 1.9 | 1.9 |
| content (wt %) | | | | | |
| Component C | 23.8 | 19.0 | 7.2 | 9.6 | 9.6 |
| content (wt %) | | | | | |
| Amide group | 2.40 | 1.92 | 0.73 | 0.97 | 0.97 |
| content (mmol/g) | | | | | |

TABLE 18

| | Polymerizable composition | | | | |
|---|---|---|---|---|---|
| | r16 | r17 | r18 | r19 | r20 |
| Component A | 95.7 | 84.2 | 77.0 | 76.8 | 87.2 |
| content (wt %) | | | | | |
| Component B | 0 | 11.5 | 1.9 | 1.9 | 0 |
| content (wt %) | | | | | |
| Component C | 2.4 | 2.4 | 19.2 | 19.4 | 7.1 |
| content (wt %) | | | | | |
| Amide group | 0.24 | 0.24 | 1.94 | 1.96 | 0.72 |
| content (mmol/g) | | | | | |

### Example 1

An antifouling film of Example 1 was produced by the method described in the above production example.

### (Process 1)

The polymerizable composition R1 was applied in a belt-like pattern. The application of the polymerizable composition R1 was performed in the following two patterns: applying the polymerizable composition R1 to a surface of the substrate 2 (hereinafter, also referred to as Pattern 1); and applying the polymerizable composition R1 to a surface of an end of the die 6 (hereinafter, also referred to as Pattern 2). The workpiece with the polymerizable composition R1 (substrate 2 and die 6) was heated in an oven at 80° C. for one minute, so that the solvent was evaporated from the polymerizable composition R1.

### (Process 2)

The substrate 2 was pushed to the die 6 with the polymerizable composition R1 (from which the solvent was evaporated) in between using a hand roller. As a result, an uneven structure was formed on a surface (the surface remote from the substrate 2) of the polymerizable composition R1.

### (Process 3)

The polymerizable composition R1 having the uneven structure on the surface thereof was irradiated with ultraviolet rays (dose: 1 J/cm²) from the substrate 2 side, so that the polymerizable composition R1 was cured. As a result, the polymer layer 3 was formed.

### (Process 4)

The die 6 was released from the polymer layer 3. As a result, the antifouling film 1 was completed.

The specifications of the polymer layer 3 were as follows in both Pattern 1 and Pattern 2.

Thickness T: 9.3 μm

Bottom temperature: 127° C.

Minimum storage modulus E′: 2.00×10⁸ Pa

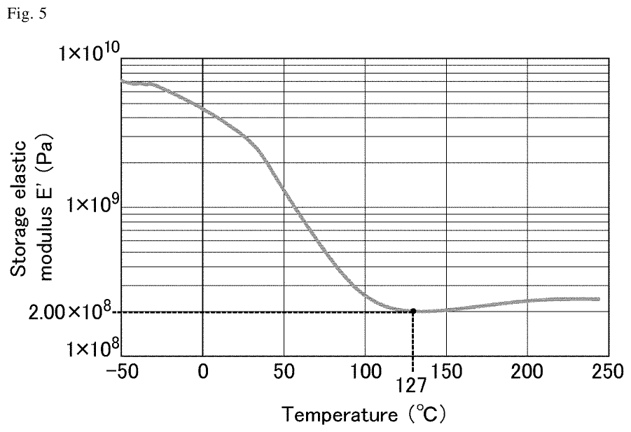

The bottom temperature and minimum storage modulus E′ of the polymer layer 3 were determined based on the storage modulus E′ that was measured with a viscoelasticity measuring apparatus “DMA7100” from Hitachi High-Tech Science Corporation within a measurement temperature range of −50° C. to 250° C. and at a temperature increasing rate of 5° C./min and a frequency of 10 Hz. The sample used for the storage modulus E′ measurement was a cured product (polymer layer 3) having a rectangular cross section (length: 35 mm, width: 5 mm, thickness: 1 mm) obtained by applying ultraviolet rays (dose: 1 J/cm²) to the polymerizable composition R1 (after solvent evaporation). The storage modulus E′ was measured with each end of the measurement sample clamped. The length of the portion not clamped was 20 mm. FIG. 5 is a graph showing the measurement results of the storage modulus E′ of the polymer layer of the antifouling film of Example 1. As shown in FIG. 5, the storage modulus E′ of the polymer layer 3 decreases as the temperature increases, and is then turned to be constant or to increase. The storage modulus E′ of the polymer layer 3 is turned to increase because the polymer layer 3 swells as the temperature increases. In FIG. 5, the bottom temperature at which the storage modulus E′ of the polymer layer 3 was minimum was 127° C., and the minimum storage modulus E′ was 2.00×10⁸ Pa.

The surface specifications of the antifouling film 1 were as follows both in Pattern 1 and Pattern 2.

Shape of projection 3: temple-bell-like shape

Average pitch of projections 4: 200 nm

Average height of projections 4: 200 nm

Average aspect ratio of projections 4: 1.0

The surface specifications of the antifouling film 1 were evaluated using a scanning electron microscope “S-4700” from Hitachi High-Technologies Corp. For the evaluation, osmium(VIII) oxide from Wako Pure Chemical Industries, Ltd. was applied (thickness: 5 nm) on the surface (the surface remote from the substrate 2) of the polymer layer 3 using an osmium coater “Neoc-ST” from Meiwafosis Co., Ltd.

### Examples 2 to 23 and Comparative Examples 1 to 20

An antifouling film of each example was produced in the same manner as in Example 1, except that the materials shown in Tables 19 to 27 were used. Tables 19 to 27 also show the bottom temperature and minimum storage modulus E′ of the polymer layer of the antifouling film of each example, which were determined in the same manner as in Example 1.

### [Evaluations]

The antifouling films of the examples were subjected to the following evaluations (some evaluations were conducted during the production of the antifouling film of each example). Tables 19 to 27 show the results.

### <Transparency>

For the transparency, the transparency of the polymerizable composition was evaluated.

### (Transparency of Polymerizable Composition)

The polymerizable composition (in the state before heating process) of each example was placed in a clear test tube, and the condition of the composition was visually observed in an environment with an illuminance of 100 1× (fluorescent lamp). The evaluation criteria were as follows.

Good: the composition was transparent or slightly cloudy.

Fair: the composition was slightly cloudy, but no precipitate was observed even after it was left to stand for one day.

Poor: the composition was cloudy, but no precipitate was observed even after it was left to stand for one day.

Bad: the composition was cloudy, and precipitates were observed after it was left to stand for one day.

A higher transparency of the polymerizable composition was determined to show a higher compatibility of the components with each other (particularly, Component B) in the polymerizable composition.

### <Antifouling Properties>

For the antifouling properties, the water repellency, the oil repellency, the ease of wiping off fingerprints, and the remaining condition after die transfer were evaluated. These evaluations were conducted for the antifouling film of each example in Pattern 1.

### (Water Repellency)

Water was dropped on the surface (the surface remote from the substrate) of the polymer layer of the antifouling film of each example, and the contact angle was measured after 10 seconds from the dropping.

### (Oil Repellency)

Hexadecane was dropped on the surface (the surface remote from the substrate) of the polymer layer of the antifouling film of each example, and the contact angle was measured after 10 seconds from the dropping.

The contact angles were each the average value of contact angles measured at the following three points by the θ/2 method (θ/2=arctan (h/r), wherein θ: contact angle, r: radius of droplet, h: height of droplet) using a portable contact angle meter “PCA-1” from Kyowa Interface Science Co., Ltd. The first measurement point selected was the central portion of the antifouling film of each example. The second and third measurement points were two points that were 20 mm or more apart from the first measurement point and were point-symmetrical to each other about the first measurement point.

### (Ease of Wiping Off Fingerprints)

First, for the antifouling film of each example, a black acrylic plate was attached to the surface remote from the polymer layer of the substrate with an optical adhesive layer in between. Next, fingerprints were attached to the surface (the surface remote from the substrate) of the polymer layer of the antifouling film of each example. Then, the surface was rubbed 10 times in a reciprocating motion using “Bemcot® S-2” from Asahi Kasei Fibers Corp. Whether the fingerprints were wiped off or not was visually observed in an environment with an illuminance of 100 1× (fluorescent lamp). The evaluation criteria were as follows.

Good: The fingerprints were completely wiped off and no wiping residue was observed.

Fair: The fingerprints were not obvious, but slight wiping residue was observed when the light from the fluorescent lamp was reflected on the surface.

Poor: The fingerprints were not wiped off at all.

The cases evaluated as good or fair were considered as within the allowable level (having excellent ease of wiping off fingerprints).

### (Remaining Condition After Die Transfer)

In the process of producing an antifouling film of each example, the surface of the die was cleaned with oxygen plasma (output: 100 W) for 20 seconds, so that the surface was adjusted to have a contact angle (contact angle after 10 seconds from the dropping) with water of 125° to 130°. This adjustment was performed in order to intendedly deteriorate the die and to achieve the same initial releasing properties of the die between the respective examples. Next, die transfer (Processes 1 to 4) was repeated 10 times for the polymerizable composition used in each example. Then, hexadecane was dropped on the surface (surface remote from the substrate) of the polymer layer of each antifouling film obtained in the first transfer and in the tenth transfer, and the contact angle after 10 seconds from the dropping was measured. The measurement results of the contact angle with hexadecane were expressed by C1 (the first transfer, unit: °) and C2 (the tenth transfer, unit: °). Using the contact angle C1 and the contact angle C2 with hexadecane, the changing rate “ΔC” (unit: %) of the contact angle with hexadecane was calculated according to the following formula (X).

ΔC=|100×(Contact angle C2−Contact angle C1)/Contact angle C1| (X)

The evaluation criteria were as follows.

Excellent: C2≥30 and ΔC<5

Good: C2≥30 and 5≤ΔC<10

Fair: C2≥30 and 10<ΔC<25

Poor: C2≥30 and 25<ΔC<50

Bad: C2<30 or ΔC≥50

The cases with excellent, good, or fair were determined that a reduction in antifouling properties (oil repellency) was suppressed even when the number of die transfer times increased.

### <Rubbing Resistance>

For the rubbing resistance, the nonwoven fabric resistance and the steel wool resistance were evaluated. These evaluations were conducted for the antifouling film of each example in Pattern 1.

### (Nonwoven Fabric Resistance)

A black acrylic plate was attached to the surface of the substrate, remote from the polymer layer of the antifouling film of each example. The surface (the surface remote from the substrate) of the polymer layer of the antifouling film of each example was irradiated with light from a light source from a polar angle of 5° and the specular spectral reflectance at an incident angle of 5° was measured. The reflectance was measured with a spectrophotometer “UV-3100PC” from Shimadzu Corporation within the wavelength range of 380 to 780 nm. The average reflectance within the wavelength range of 450 to 650 nm was calculated based on the measurement results. The average reflectance is referred to as Reflectance F1 (unit: %).

The surface (the surface remote from the substrate) of the polymer layer of the antifouling film of each example was rubbed 10 times in a reciprocating motion with “BEMCOT LABO®” from Asahi Kasei Fibers Corp. The specular spectral reflectance at an incident angle of 5° of the antifouling film of each example was measured by the same procedure as described above. The average reflectance within the wavelength range of 450 to 650 nm was calculated based on the measurement results. The average reflectance is referred to as Reflectance F2 (unit: %).

Based on Reflectance F1 and Reflectance F2 determined as described above, the changing rate “AF” (unit: %) of the reflectance was calculated according of the following formula (Y).

ΔF=|100×(Reflectance F2−Reflectance F1)/Reflectance F1|(Y)

The determination criteria were as follows.

Excellent: ΔF≤15

Good: 15≤ΔF<25

Fair: 25≤ΔF≤30

Poor: 30≤ΔF<50

Bad: ΔF≤50

Antifouling films (polymer layers) with the determination result of excellent, good, or fair were considered as within the allowable level (excellent in nonwoven fabric resistance) at which the antifouling film (polymer layer) does not appear white.

The above evaluation for the nonwoven fabric resistance is made assuming the following phenomenon. For example, with a low nonwoven fabric resistance (in particular, when the minimum storage modulus E′ of the polymer layer is low), rubbing the surface (the surface remote from the substrate) of the polymer layer of the antifouling film with a nonwoven fabric may cause troubles such as that the projections stick to each other and do not return to the original state, that the projections are fallen and do not rise again, and that the projections are broken. This may lead to different reflectances of a portion with a trouble and a portion with no trouble, causing the portion with a trouble of the antifouling film (polymer layer) to appear white. In other words, an antifouling film with a low nonwoven fabric resistance shows a large change in reflectance before and after rubbing of the surface.

### (Steel Wool Resistance)

First, the surface (the surface remote from the substrate) of the polymer layer of the antifouling film of each example was rubbed with steel wool “#0000” from Nippon Steel Wool Co., Ltd. with a load of 400 g applied to the steel wool. The surface (the surface remote from the substrate) of the polymer layer of the antifouling film of each example was visually observed in an environment with an illuminance of 100 1× (fluorescent lamp) and the number “N” of scratches on the surface was counted. The surface was rubbed with the steel wool using a surface property tester “HEIDON®-14FW” from Shinto Scientific Co., Ltd. as the test machine, with a stroke width of 30 mm, a rate of 100 mm/s, and the number of times of rubbing of 10 in a reciprocating motion. The evaluation criteria were as follows.

A: N=0

B: N=1 to 3

C: N=4 to 10

D: N=11 to 20

E: N≤21

The cases evaluated as A, B, or C were considered as within the allowable level (having excellent steel wool resistance).

### <Adhesion>

The adhesion of the antifouling film of each example in Patterns 1 and 2 was evaluated by the following method. Pattern 2 is less likely to distribute active components in Component B (fluorine-based release agent) on the surface (the surface remote from the substrate) of the polymer layer at a high concentration, i.e., more likely to distribute active components in Component B on the substrate side of the polymer layer, than Pattern 1. Hence, Pattern 2 is supposed to cause lower adhesion than Pattern 1.

First, at a temperature of 23° C. and a humidity of 50%, 11 vertical cuts and 11 horizontal cuts were made in a grid pattern with 1 mm spacing on the surface (the surface remote from the substrate) of the polymer layer of the antifouling film of each example using a snap-off utility knife. Thereby, 100 squares (1 mm square) were formed. Then, polyester adhesive tape “No. 31B” from Nitto Denko Corp. was press-applied to the squares and peeled off in the 90° direction relative to the surface of the squares at a rate of 100 mm/s. The state of the polymer layer on the substrate after the peeling was visually observed. The number M (unit: piece) of squares in which the polymer layer was not peeled off but left on the substrate) was counted. The evaluation criteria were as follows. (Adhesion in Pattern 1)

A: M=100

B: M=1 to 99

C: M=0

The cases evaluated as A were considered as within the allowable level (having excellent adhesion in Pattern 1).

### (Adhesion in Pattern 2)

a: M=100

b: M=90 to 99

c: M=0 to 89

The cases evaluated as a or b were considered as within the allowable level (having excellent adhesion in Pattern 2).

The comprehensive evaluation of the adhesion was made based on the adhesion in Pattern 1 and the adhesion in Pattern 2. The evaluation criteria were as follows.

Good: The adhesion in Pattern 1 was A and the adhesion in Pattern 2 was a.

Fair: The adhesion in Pattern 1 was A and the adhesion in Pattern 2 was b.

Poor: The adhesion in Pattern 1 was B or C and/or the adhesion in Pattern 2 was c.

The cases evaluated comprehensively as good or fair were considered as within the allowable level (having excellent adhesion).

### <Reliability>

For the reliability, the bleed-out state was evaluated. This evaluation was conducted for the antifouling film of each example in Pattern 1.

### (Bleed-Out State)

The antifouling film of each example was subjected to a high temperature/high humidity test where the film was left at a temperature of 60° C. and a humidity of 95% for 1000 hours. The cloudiness level of the polymer layer of the antifouling film of each example was visually observed in an environment with an illuminance of 100 1× (fluorescent lamp). The antifouling films whose polymer layer did not turn cloudy as a result of the visual observation were determined as not causing bleed-out, and were therefore evaluated as having good reliability. The antifouling films whose polymer layer turned cloudy were determined as causing bleed-out, and were therefore evaluated as having poor reliability.

When determination by visual observation is difficult, the specular reflection spectra at an angle of incidence of 5° measured before and after the high temperature/high humidity test were superposed on each other, and the reliability was evaluated based on whether or not the spectra were aligned. Specifically, the antifouling films with the same reflectance in the spectra before and after the high temperature/high humidity test were determined as having good reliability, and the antifouling films with different reflectances in the spectra before and after the high temperature/high humidity test (when the overall reflectance increased after the high temperature/high humidity test) were determined as having poor reliability. The specular spectrum at an angle of incidence of 5° was measured as follows. A black acrylic plate was attached to the surface remote from the polymer layer of the substrate of the antifouling film of each example. The surface (the surface remote from the substrate) of the polymer layer of the antifouling film of each example was irradiated with light from a light source at a polar angle of 5°, so that the specular reflection spectrum was measured within a wavelength range from 380 to 780 nm using “UV-3100PC” from Shimadzu Corporation.

TABLE 19

| | | | Example 1 | Example 2 | Example 3 | Example 4 | Example 5 |
|---|---|---|---|---|---|---|---|
| Polymerizable composition | | | R1 | R2 | R3 | R4 | R5 |
| Bottom temperature (° C.) of polymer layer | | | 127 | 135 | 144 | 122 | 93 |
| Minimum storage modulus E′ (×10⁸ Pa) of polymer | | | 2.00 | 1.70 | 2.40 | 1.30 | 0.92 |
| layer | | | | | | | |
| Transparency | Transparency of polymerizable | | Good | Good | Good | Good | Good |
| | composition | | | | | | |
| Antifouling | Water repellency | Contact angle (°) | 158 | 156 | 157 | 155 | 159 |
| properties | | with water | | | | | |
| | Oil repellency | Contact angle (°) | 88 | 87 | 88 | 85 | 89 |
| | | with hexadecane | | | | | |
| | Ease of wiping off fingerprints | | Good | Good | Good | Good | Good |
| | Remaining condition after die | | Excellent | Excellent | Excellent | Excellent | Excellent |
| | transfer | | | | | | |
| Rubbing | Nonwoven fabric resistance | | Excellent | Excellent | Excellent | Good | Fair |
| resistance | Steel wool resistance | | Excellent | Good | Fair | Excellent | Good |
| Adhesion | Pattern 1 | Result: M (pcs) | 100 | 100 | 100 | 100 | 100 |
| | | Evaluation | A | A | A | A | A |
| | Pattern 2 | Result: M (pcs) | 100 | 100 | 100 | 100 | 100 |
| | | Evaluation | a | a | a | a | a |

| | | | | | | |
|---|---|---|---|---|---|---|
| | Comprehensive evaluation | Good | Good | Good | Good | Good |
| Reliability | Bleed-out state | Good | Good | Good | Good | Good |

TABLE 20

| | | | Example 6 | Example 7 | Example 8 | Example 9 | Example 10 |
|---|---|---|---|---|---|---|---|
| Polymerizable composition | | | R6 | R7 | R8 | R9 | R10 |
| Bottom temperature (° C.) of polymer layer | | | 131 | 134 | 122 | 123 | 137 |
| Minimum storage modulus E′ (×10⁸ Pa) of polymer | | | 2.60 | 2.80 | 2.20 | 1.30 | 1.40 |
| layer | | | | | | | |
| Transparency | Transparency of polymerizable | | Good | Good | Good | Good | Good |
| | composition | | | | | | |
| Antifouling | Water repellency | Contact angle (°) | 157 | 156 | 148 | 150 | 154 |
| properties | | with water | | | | | |
| | Oil repellency | Contact angle (°) | 88 | 84 | 75 | 80 | 82 |
| | | with hexadecane | | | | | |
| | Ease of wiping off fingerprints | | Good | Good | Good | Good | Good |
| | Remaining condition after die | | Excellent | Excellent | Good | Good | Fair |
| | transfer | | | | | | |
| Rubbing | Nonwoven fabric resistance | | Excellent | Excellent | Excellent | Excellent | Excellent |
| resistance | Steel wool resistance | | Good | Good | Excellent | Excellent | Good |
| Adhesion | Pattern 1 | Result: M (pcs) | 100 | 100 | 100 | 100 | 100 |
| | | Evaluation | A | A | A | A | A |
| | Pattern 2 | Result: M (pcs) | 98 | 92 | 95 | 97 | 100 |
| | | Evaluation | b | b | b | b | a |

| | | | | | | |
|---|---|---|---|---|---|---|
| | Comprehensive evaluation | Fair | Fair | Fair | Fair | Good |
| Reliability | Bleed-out state | Good | Good | Good | Good | Good |

TABLE 21

| | | | Example 11 | Example 12 | Example 13 | Example 14 | Example 15 |
|---|---|---|---|---|---|---|---|
| Polymerizable composition | | | R11 | R12 | R13 | R14 | R15 |
| Bottom temperature (° C.) of polymer layer | | | 110 | 91 | 110 | 102 | 145 |
| Minimum storage modulus E′ (×10⁸ Pa) of polymer | | | 0.90 | 0.94 | 0.90 | 1.20 | 4.10 |
| layer | | | | | | | |
| Transparency | Transparency of polymerizable | | Good | Good | Good | Good | Good |
| | composition | | | | | | |
| Antifouling | Water repellency | Contact angle (°) | 150 | 152 | 157 | 152 | 135 |
| properties | | with water | | | | | |
| | Oil repellency | Contact angle (°) | 81 | 84 | 84 | 81 | 42 |
| | | with hexadecane | | | | | |
| | Ease of wiping off fingerprints | | Good | Good | Good | Good | Fair |
| | Remaining condition after die | | Good | Good | Good | Good | Good |
| | transfer | | | | | | |
| Rubbing | Nonwoven fabric resistance | | Fair | Fair | Fair | Good | Fair |
| resistance | Steel wool resistance | | Good | Good | Good | Excellent | Fair |
| Adhesion | Pattern 1 | Result: M (pcs) | 100 | 100 | 100 | 100 | 100 |
| | | Evaluation | A | A | A | A | A |
| | Pattern 2 | Result: M (pcs) | 100 | 100 | 100 | 100 | 100 |
| | | Evaluation | a | a | a | a | a |

| | | | | | | |
|---|---|---|---|---|---|---|
| | Comprehensive evaluation | Good | Good | Good | Good | Good |
| Reliability | Bleed-out state | Good | Good | Good | Good | Good |

TABLE 22

| | | | Example 16 | Example 17 | Example 18 | Example 19 |
|---|---|---|---|---|---|---|
| Polymerizable composition | | | R16 | R17 | R18 | R19 |
| Bottom temperature (° C.) of polymer layer | | | 125 | 130 | 124 | 120 |
| Minimum storage modulus E′ (×10⁸ Pa) of polymer | | | 2.10 | 1.70 | 2.10 | 2.00 |
| layer | | | | | | |
| Transparency | Transparency of polymerizable | | Good | Fair | Good | Good |
| | composition | | | | | |
| Antifouling | Water repellency | Contact angle (°) | 137 | 160 | 142 | 163 |
| properties | | with water | | | | |
| | Oil repellency | Contact angle (°) | 44 | 92 | 54 | 97 |
| | | with hexadecane | | | | |
| | Ease of wiping off fingerprints | | Fair | Good | Good | Good |
| | Remaining condition after die | | Good | Excellent | Fair | Excellent |
| | transfer | | | | | |
| Rubbing | Nonwoven fabric resistance | | Good | Good | Excellent | Excellent |
| resistance | Steel wool resistance | | Good | Good | Good | Excellent |
| Adhesion | Pattern 1 | Result: M (pcs) | 100 | 100 | 100 | 100 |
| | | Evaluation | A | A | A | A |
| | Pattern 2 | Result: M (pcs) | 100 | 100 | 94 | 97 |
| | | Evaluation | a | a | b | b |

| | | | | | |
|---|---|---|---|---|---|
| | Comprehensive evaluation | Good | Good | Fair | Fair |
| Reliability | Bleed-out state | Good | Good | Good | Good |

TABLE 23

| | | | Example 20 | Example 21 | Example 22 | Example 23 |
|---|---|---|---|---|---|---|
| Polymerizable composition | | | R20 | R21 | R22 | R23 |
| Bottom temperature (° C.) of polymer layer | | | 121 | 125 | 128 | 111 |
| Minimum storage modulus E′ (×10⁸ Pa) of polymer | | | 2.10 | 2.20 | 2.30 | 1.20 |
| layer | | | | | | |
| Transparency | Transparency of polymerizable | | Good | Good | Good | Good |
| | composition | | | | | |
| Antifouling | Water repellency | Contact angle (°) | 161 | 146 | 144 | 151 |
| properties | | with water | | | | |
| | Oil repellency | Contact angle (°) | 94 | 74 | 72 | 81 |
| | | with hexadecane | | | | |
| | Ease of wiping off fingerprints | | Good | Good | Good | Good |
| | Remaining condition after die | | Excellent | Good | Excellent | Good |
| | transfer | | | | | |
| Rubbing | Nonwoven fabric resistance | | Excellent | Excellent | Excellent | Excellent |
| resistance | Steel wool resistance | | Excellent | Excellent | Excellent | Excellent |
| Adhesion | Pattern 1 | Result: M (pcs) | 100 | 100 | 100 | 100 |
| | | Evaluation | A | A | A | A |
| | Pattern 2 | Result: M (pcs) | 98 | 91 | 100 | 98 |
| | | Evaluation | b | b | a | b |

| | | | | | |
|---|---|---|---|---|---|
| | Comprehensive evaluation | Fair | Fair | Good | Fair |
| Reliability | Bleed-out state | Good | Good | Good | Good |

TABLE 24

| | | | Comparative | Comparative | Comparative | Comparative | Comparative |
|---|---|---|---|---|---|---|---|
| | | | Example 1 | Example 2 | Example 3 | Example 4 | Example 5 |
| Polymerizable composition | | | r1 | r2 | r3 | r4 | r5 |
| Bottom temperature (° C.) of polymer layer | | | 136 | 109 | 130 | 141 | 112 |
| Minimum storage modulus E′ (× 10⁸ Pa) of polymer | | | 2.90 | 4.30 | 1.30 | 2.00 | 1.00 |
| layer | | | | | | | |
| Transparency | Transparency of polymerizable | | Good | Good | Good | Good | Good |
| | composition | | | | | | |
| Antifouling | Water repellency | Contact angle (°) | 155 | 138 | 154 | 151 | 148 |
| properties | | with water | | | | | |
| | Oil repellency | Contact angle (°) | 86 | 43 | 86 | 84 | 54 |
| | | with hexadecane | | | | | |
| | Ease of wiping off fingerprints | | Good | Fair | Good | Good | Good |
| | Remaining condition after die | | Excellent | Excellent | Poor | Poor | Poor |
| | transfer | | | | | | |
| Rubbing | Nonwoven fabric resistance | | Excellent | Excellent | Excellent | Excellent | Fair |
| resistance | Steel wool resistance | | Good | Fair | Excellent | Good | Excellent |
| Adhesion | Pattern 1 | Result: M (pcs) | 100 | 0 | 100 | 100 | 100 |
| | | Evaluation | A | C | A | A | A |
| | Pattern 2 | Result: M (pcs) | 45 | 0 | 100 | 100 | 95 |
| | | Evaluation | c | c | a | a | b |

| | | | | | | |
|---|---|---|---|---|---|---|
| | Comprehensive evaluation | Poor | Poor | Good | Good | Fair |
| Reliability | Bleed-out state | Good | Good | Good | Good | Good |

TABLE 25

| | | | Comparative | Comparative | Comparative | Comparative | Comparative |
|---|---|---|---|---|---|---|---|
| | | | Example 6 | Example 7 | Example 8 | Example 9 | Example 10 |
| Polymerizable composition | | | r6 | r7 | r8 | r9 | r10 |
| Bottom temperature (° C.) of polymer layer | | | 170 | 210 | 125 | 116 | 160 |
| Minimum storage modulus E′ (× 10⁸ Pa) of polymer | | | 2.20 | 1.80 | 0.77 | 0.85 | 2.40 |
| layer | | | | | | | |
| Transparency | Transparency of polymerizable | | Good | Good | Good | Good | Good |
| | composition | | | | | | |
| Antifouling | Water repellency | Contact angle (°) | 149 | 139 | 146 | 157 | 145 |
| properties | | with water | | | | | |
| | Oil repellency | Contact angle (°) | 80 | 40 | 78 | 86 | 58 |
| | | with hexadecane | | | | | |
| | Ease of wiping off fingerprints | | Good | Fair | Good | Good | Good |
| | Remaining condition after die | | Poor | Bad | Bad | Bad | Bad |
| | transfer | | | | | | |
| Rubbing | Nonwoven fabric resistance | | Good | Poor | Poor | Poor | Excellent |
| resistance | Steel wool resistance | | Poor | Bad | Fair | Poor | Poor |
| Adhesion | Pattern 1 | Result: M (pcs) | 100 | 100 | 100 | 50 | 100 |
| | | Evaluation | A | A | A | B | A |
| | Pattern 2 | Result: M (pcs) | 94 | 100 | 100 | 0 | 94 |
| | | Evaluation | b | a | a | c | b |

| | | | | | | |
|---|---|---|---|---|---|---|
| | Comprehensive evaluation | Fair | Good | Good | Poor | Fair |
| Reliability | Bleed-out state | Good | Good | Good | Good | Good |

TABLE 26

| | | | Comparative | Comparative | Comparative | Comparative | Comparative |
|---|---|---|---|---|---|---|---|
| | | | Example 11 | Example 12 | Example 13 | Example 14 | Example 15 |
| Polymerizable composition | | | r11 | r12 | r13 | r14 | r15 |
| Bottom temperature (° C.) of polymer layer | | | 233 | 186 | 196 | 170 | 92 |
| Minimum storage modulus E′ (× 10⁸ Pa) of polymer | | | 6.40 | 2.70 | 4.10 | 3.40 | 0.87 |
| layer | | | | | | | |
| Transparency | Transparency of polymerizable | | Good | Good | Good | Good | Good |
| | composition | | | | | | |
| Antifouling | Water repellency | Contact angle (°) | 139 | 134 | 145 | 147 | 156 |
| properties | | with water | | | | | |
| | Oil repellency | Contact angle (°) | 42 | 37 | 78 | 75 | 84 |
| | | with hexadecane | | | | | |
| | Ease of wiping off fingerprints | | Fair | Fair | Good | Good | Good |
| | Remaining condition after die | | Bad | Bad | Good | Good | Good |
| | transfer | | | | | | |
| Rubbing | Nonwoven fabric resistance | | Fair | Good | Fair | Good | Poor |
| resistance | Steel wool resistance | | Bad | Poor | Bad | Poor | Fair |
| Adhesion | Pattern 1 | Result: M (pcs) | 100 | 100 | 100 | 100 | 100 |
| | | Evaluation | A | A | A | A | A |
| | Pattern 2 | Result: M (pcs) | 100 | 100 | 100 | 100 | 100 |
| | | Evaluation | a | a | a | a | a |

| | | | | | | |
|---|---|---|---|---|---|---|
| | Comprehensive evaluation | Good | Good | Good | Good | Good |
| Reliability | Bleed-out state | Good | Good | Good | Good | Good |

TABLE 27

| | | | Comparative | Comparative | Comparative | Comparative | Comparative |
|---|---|---|---|---|---|---|---|
| | | | Example 16 | Example 17 | Example 18 | Example 19 | Example 20 |
| Polymerizable composition | | | r16 | r17 | r18 | r19 | r20 |
| Bottom temperature (° C.) of polymer layer | | | 125 | 130 | 83 | 202 | 123 |
| Minimum storage modulus E′ (× 10⁸ Pa) of polymer | | | 2.10 | 1.70 | 0.84 | 4.90 | 2.00 |
| layer | | | | | | | |
| Transparency | Transparency of polymerizable | | Good | Poor | Good | Good | Good |
| | composition | | | | | | |
| Antifouling | Water repellency | Contact angle (°) | 18 | 157 | 155 | 154 | 45 |
| properties | | with water | | | | | |
| | Oil repellency | Contact angle (°) | 13 | 89 | 85 | 84 | 15 |
| | | with hexadecane | | | | | |
| | Ease of wiping off fingerprints | | Poor | Fair | Good | Good | Poor |
| | Remaining condition after die | | Bad | Excellent | Bad | Bad | Bad |
| | transfer | | | | | | |
| Rubbing | Nonwoven fabric resistance | | Poor | Fair | Poor | Fair | Good |
| resistance | Steel wool resistance | | Poor | Poor | Poor | Poor | Fair |
| Adhesion | Pattern 1 | Result: M (pcs) | 100 | 100 | 100 | 100 | 100 |
| | | Evaluation | A | A | A | A | A |
| | Pattern 2 | Result: M (pcs) | 100 | 100 | 100 | 100 | 94 |
| | | Evaluation | a | a | a | a | b |

| | | | | | | |
|---|---|---|---|---|---|---|
| | Comprehensive evaluation | Good | Good | Good | Good | Fair |
| Reliability | Bleed-out state | Good | Poor | Good | Good | Good |

As shown in Tables 19 to 23, Examples 1 to 23 each achieved an antifouling film that was excellent in the antifouling properties, rubbing resistance, and adhesion. Also in Examples 1 to 23, a reduction in antifouling properties was suppressed even when the number of die transfer times increased. Furthermore, in Examples 1 to 23, the transparency of the polymerizable composition was high and the reliability thereof was excellent.

In Examples 19 and 20, the antifouling properties (particularly, water repellency and oil repellency) and the rubbing resistance were significantly high since the first fluorine-based release agent containing a perfluoro polyether group and the second fluorine-based release agent containing a perfluoro alkyl group were used together as the fluorine-based release agents.

In contrast, as shown in Tables 24 to 27, Comparative Examples 1 to 20 each failed to achieve an antifouling film that was excellent in the antifouling properties, rubbing resistance, and adhesion.

In Comparative Example 1, the adhesion was low since the polymerizable composition had a Component C content of lower than 1 wt % in terms of active components.

In Comparative Example 2, the adhesion was very low since the polymerizable composition did not contain Component C.

In Comparative Examples 3 to 12, 18, and 19, the antifouling properties decreased as the number of die transfer times increased since the polymerizable composition had a Component C content of higher than 14 wt % in terms of active components. Specifically, in Comparative Examples 6, 7, and 10 to 12, the steel wool resistance was particularly low since the bottom temperature of the polymer layer was higher than 150° C. In Comparative Examples 8 and 9, the nonwoven fabric resistance was particularly low since the minimum storage modulus E′ of the polymer layer was lower than 0.9×10⁸ Pa. In Comparative Example 18, the nonwoven fabric resistance was particularly low since the bottom temperature of the polymer layer was lower than 90° C. In Comparative Example 19, the steel wool resistance was particularly low since the minimum storage modulus E′ of the polymer layer was higher than 4.5×10⁸ Pa.

In Comparative Examples 13 and 14, the steel wool resistance was particularly low since the bottom temperature of the polymer layer was higher than 150° C.

In Comparative Example 15, the nonwoven fabric resistance was particularly low since the minimum storage modulus E′ of the polymer layer was lower than 0.9×10⁸ Pa.

In Comparative Example 16, the antifouling properties and the rubbing resistance were low since the polymerizable composition did not contain Component B.

In Comparative Example 17, the rubbing resistance was low since the polymerizable composition had a Component B content of higher than 10 wt % in terms of active components. Also, the transparency of the polymerizable composition and reliability were low since Component B was insolubilized.

In Comparative Example 20, the antifouling properties were low since the polymerizable composition contained not Component B but a silicon-based release agent.

### [Additional Remarks]

One aspect of the present invention may be an antifouling film including: a substrate; and a polymer layer disposed on a surface of the substrate and including on a surface thereof an uneven structure provided with projections at a pitch not longer than a wavelength of visible light, the polymer layer being a cured product of a polymerizable composition, the polymerizable composition containing, in terms of active components, 75 to 98 wt % of a polyfunctional acrylate, 0.5 to 10 wt % of a fluorine-based release agent, and 1 to 14 wt % of a monofunctional amide monomer, the polymer layer having a bottom temperature at which a storage modulus E′ of the polymer layer is minimum of 90° C. to 150° C. and a minimum storage modulus E′ of 0.9×10⁸ to 4.5×10⁸ Pa in a dynamic viscoelasticity measurement within a measurement temperature range of −50° C. to 250° C. and at a temperature increasing rate of 5° C./min and a frequency of 10 Hz. This aspect can achieve an antifouling film excellent in antifouling properties, rubbing resistance, and adhesion. This aspect also suppresses a reduction in antifouling properties even when the number of die transfer times increases.

The polyfunctional acrylate may include a bifunctional acrylate that contains 2 to 10 ethylene oxide groups for each molecule, and the polymerizable composition may contain 30 to 90 wt % of the bifunctional acrylate in terms of active components. This structure can further increase the rubbing resistance and the adhesion.

The bifunctional acrylate may include 2-(2-vinyloxyethoxy)ethyl acrylate, and the polymerizable composition may contain 20 to 60 wt % of the 2-(2-vinyloxyethoxy)ethyl acrylate in terms of active components. This structure tends to increase the rubbing resistance and the adhesion.

The fluorine-based release agent may include one or both of a first fluorine-based release agent containing a perfluoro polyether group and a second fluorine-based release agent containing a perfluoro alkyl group. This structure achieves better antifouling properties and rubbing resistance than the case of using release agents (e.g., silicon-based release agents, organophosphate-based release agents) other than fluorine-based release agents.

The fluorine-based release agent may include both of the first fluorine-based release agent and the second fluorine-based release agent. This structure tends to allow easy distribution (move) of the first fluorine-based release agent on (to) the surface (the surface remote from the substrate) of the polymer layer by the act of the second fluorine-based release agent to achieve significantly better antifouling properties and rubbing resistance than the case of using one of the first fluorine-based release agent and the second fluorine-based release agent alone.

The monofunctional amide monomer may include N,N-dimethylacrylamide. This structure more increases the compatibility of the monofunctional amide monomer with the polyfunctional acrylate and the fluorine-based release agent since the N,N-dimethyl acrylamide has a relatively low viscosity.

The monofunctional amide monomer may include N-acryloyl morpholine. This structure causes the monofunctional amide monomer to tend to be incompatible with the release treatment agent (e.g., fluorine-based material (having a low polarity)) of the die since the N-acryloyl morpholine has a relatively high viscosity and a relatively high polarity. Thus, the release treatment agent is less likely to separate from the die even when the number of die transfer times increases, whereby a reduction in releasing properties is sufficiently suppressed.

The polymer layer may have a surface that shows a contact angle of 130° or greater with water and a contact angle of 30° or greater with hexadecane. This structure more increases antifouling properties.

The polymer layer may have a thickness of 5.0 to 20.0 μm. This structure allows the active components in the fluorine-based release agent to be distributed on the surface (the surface remote from the substrate) of the polymer layer at a high concentration.

The projections may be formed at an average pitch of 100 to 400 nm. This structure sufficiently prevents occurrence of optical phenomena such as moire and iridescence.

The projections may have an average height of 50 to 600 nm. This structure can simultaneously achieve a preferred average height and a preferred average aspect ratio of the projections.

The projections may have an average aspect ratio of 0.8 to 1.5. This structure sufficiently prevents occurrence of optical phenomena such as moire and iridescence to achieve excellent antireflection properties. This structure also sufficiently prevents sticking of the projections and deterioration of transfer condition in formation of the uneven structure, which are caused by a reduction in processability of the uneven structure.

### REFERENCE SIGNS LIST

1: Antifouling film
2: Substrate
3: Polymer layer
4: Projection
5: Polymerizable composition
6: Die
P: Pitch of projections
H: Height of projection
T: Thickness of polymer layer

1. An antifouling film comprising:
a substrate; and
a polymer layer disposed on a surface of the substrate and including on a surface thereof an uneven structure provided with projections at a pitch not longer than a wavelength of visible light,
the polymer layer being a cured product of a polymerizable composition,
the polymerizable composition containing, in terms of active components, 75 to 98 wt % of a polyfunctional acrylate, 0.5 to 10 wt % of a fluorine-based release agent, and 1 to 14 wt % of a monofunctional amide monomer,
the polymer layer having a bottom temperature at which a storage modulus E′ of the polymer layer is minimum of 90° C. to 150° C. and a minimum storage modulus E′ of 0.9×108 to 4.5×108 Pa in a dynamic viscoelasticity measurement within a measurement temperature range of −50° C. to 250° C. and at a temperature increasing rate of 5° C./min and a frequency of 10 Hz.

2. The antifouling film according to claim 1,
wherein the polyfunctional acrylate includes a bifunctional acrylate that contains 2 to 10 ethylene oxide groups for each molecule, and
the polymerizable composition contains 30 to 90 wt % of the bifunctional acrylate in terms of active components.

3. The antifouling film according to claim 2,
wherein the bifunctional acrylate includes 2-(2-vinyloxyethoxy)ethyl acrylate, and
the polymerizable composition contains 20 to 60 wt % of the 2-(2-vinyloxyethoxy)ethyl acrylate in terms of active components.

4. The antifouling film according to claim 1,
wherein the fluorine-based release agent includes one or both of a first fluorine-based release agent containing a perfluoro polyether group and a second fluorine-based release agent containing a perfluoro alkyl group.

5. The antifouling film according to claim 4,
wherein the fluorine-based release agent includes both of the first fluorine-based release agent and the second fluorine-based release agent.

6. The antifouling film according to claim 1,
wherein the monofunctional amide monomer includes N,N-dimethylacrylamide.

7. The antifouling film according to claim 1,
wherein the monofunctional amide monomer includes N-acryloyl morpholine.

8. The antifouling film according to claim 1,
wherein the polymer layer has a surface that shows a contact angle of 130° or greater with water and a contact angle of 30° or greater with hexadecane.

9. The antifouling film according to claim 1,
wherein the polymer layer has a thickness of 5.0 to 20.0 μm.

10. The antifouling film according to claim 1,
wherein the projections are formed at an average pitch of 100 to 400 nm.

11. The antifouling film according to claim 1,
wherein the projections have an average height of 50 to 600 nm.

12. The antifouling film according to claim 1,
wherein the projections have an average aspect ratio of 0.8 to 1.5.
